(19) United States
(12) Patent Application Publication
(10) Pub. No.: US 2021/0110414 A1
(43) Pub. Date: Apr. 15, 2021

(54) CONTEXTUAL INTELLIGENT POLL BUBBLES FOR COMMUNICATION, COLLABORATION AND MESSAGING EVENTS

(71) Applicant: Microsoft Technology Licensing, LLC, Redmond, WA (US)

(72) Inventors: Jason Thomas FAULKNER, Seattle, WA (US); Tiphanie LAU, Seattle, WA (US); Rajiv RAMAIAH, Bellevue, WA (US); Sonu ARORA, Kirkland, WA (US)

(73) Assignee: Microsoft Technology Licensing, LLC, Redmond, WA (US)

(21) Appl. No.: 16/653,645

(22) Filed: Oct. 15, 2019

(51) Int. Cl. G06Q 30/02; G06Q 50/00; G06N 20/00; G06F 3/0484; G06F 3/0481; G06F 3/0482

(52) U.S. Cl. CPC G06Q 30/0203; G06Q 50/01; G06N 20/00; G06Q 2230/00; G06F 3/04817; G06F 3/0482; G06F 3/0484

(57) ABSTRACT

A system and method for displaying a dashboard interface associated with a plurality of polls is provided. The system and method may receive a user identifier uniquely identifying a user of a system, determine one or more organizational units associated with the user identifier, and cause a dashboard interface associated with a plurality of polls to be rendered at a display, wherein information of a first poll associated with a first organizational unit of the one or more organizational units is provided in a first portion of the dashboard interface and information of a second poll associated with a second organizational unit of the one or more organizational units is provided in a second portion of the dashboard interface.

### BACKGROUND

Communication environments allow users of devices to communicate across a computer network such as the interne. Communication events which can be established include voice calls, video calls, instant messaging, voice mail, file transfer and others. It is known for a user of an instant messaging communication session to create a poll and share the poll with other users of the instant messaging communication session during the session to receive their feedback. The user creating the poll specifies each poll option manually. For example, a user creating a poll to enable a group of friends to decide where to go for lunch finds out the names of nearby restaurants, enters them manually as poll options and shares the poll with the rest of the group. However, manually placed objects designed to collect and report data at a one dimensional level do not take into account poll activity data across environments and groups do not extend user engagement beyond the immediate poll creation and response.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for displaying a dashboard interface associated with a plurality of polls. Polls existing in context to chat and channel activity may be manually placed objects or bots designed to collect and report data at a first dimensional level. Poll bubbles however, encourage, engage, collect and expose poll activity data across environments and groups via improved and new multi-dimensional inputs, context, bubble personality and outputs, thereby allowing for group activity, location proximity, role activity, user inputs, data collection, machine pattern learning, intelligent agent suggestions, etc. to push to the top level of a user experience. By including polling activity across applications, systems, environments, and devices, the lifecycle of the group poll activity is better contextually exposed via the reach of poll bubble states across pre, during and post engagement activity and results including unique data input capture and output curation. Thus, for example, quick slider expression of depth of input, word cloud curation results, role based live activity results, suggestive poll content opportunities, pre curated polling options and suggestions, etc. may be made readily available to aid in decision making processes going forward. In some examples, polls may be displayed in an admin user interface. Accordingly, a user identifier uniquely identifying a user of a system is received. One or more organizational units associated with the user identifier may be determined and a dashboard interface associated with a plurality of polls to be rendered may be rendered. In some examples, information of a first poll associated with a first organizational unit of the one or more organizational units and based on a first role associated with the user identifier is provided in a first portion of the dashboard interface, and information of a second poll associated with a second organizational unit of the one or more organizational units and based on a second role associated with the user identifier is provided in a second portion of the dashboard interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a communication, messaging, conferencing, and collaboration system in accordance with the aspects a of the disclosure;

FIG. 2A depicts additional details of a first graphical user interface in accordance with examples of the present disclosure;

FIG. 2B depicts additional details of a second graphical user interface in accordance with examples of the present disclosure;

FIG. 2C depicts additional details of a third graphical user interface in accordance with examples of the present disclosure;

FIG. 2D depicts additional details of a fourth graphical user interface in accordance with examples of the present disclosure;

FIG. 2E depicts additional details of a fifth graphical user interface in accordance with examples of the present disclosure;

FIG. 2F depicts additional details of a sixth graphical user interface in accordance with examples of the present disclosure;

FIG. 2G depicts additional details of a seventh graphical user interface in accordance with examples of the present disclosure;

FIG. 2H depicts additional details of a eighth graphical user interface in accordance with examples of the present disclosure;

FIG. 2I depicts additional details of a ninth graphical user interface in accordance with examples of the present disclosure;

FIG. 2J depicts additional details of a tenth graphical user interface in accordance with examples of the present disclosure;

FIG. 2K depicts additional details of a eleventh graphical user interface in accordance with examples of the present disclosure;

FIG. 2L depicts additional details of a twelfth graphical user interface in accordance with examples of the present disclosure;

FIG. 2M depicts additional details of a thirteenth graphical user interface in accordance with examples of the present disclosure;

FIG. 2N depicts additional details of a fourteenth graphical user interface in accordance with examples of the present disclosure;

FIG. 3 depicts details of the communication, messaging, conferencing, and collaboration system in accordance with examples of the present disclosure;

FIG. 4 depicts additional details of the messaging, conferencing, and collaboration system for generating and displaying a polling admin dashboard in accordance with examples of the present disclosure;

FIG. 5 depicts details of one or more data structures in accordance with examples of the present disclosure;

FIG. 6 depicts details of a method for determining polling information for display at an admin dashboard in accordance with examples of the present disclosure;

FIG. 7 depicts details of a method for determining if a user has modification rights to change or modify an existing poll in accordance with examples of the present disclosure;

FIG. 8 depicts additional details of a poll object wrapper in accordance with examples of the present disclosure;

FIG. 9 is a block diagram illustrating example physical components of a computing device with which aspects of the disclosure may be practiced;

FIG. 10A is a simplified block diagram of a computing device with which aspects of the present disclosure may be practiced;

FIG. 10B is another are simplified block diagram of a mobile computing device with which aspects of the present disclosure may be practiced; and

FIG. 11 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

As discussed above, in examples where polling may be utilized during events, integrating one or more polling features with one or more existing applications utilized by users, increases usability and provides at least one manner for obtaining user feedback. Moreover, for polls that may have been missed by a user for reasons of user inactivity, a messaging or conference system, upon a login by the user or upon reopening the app after leaving or being inactive for a predetermined amount of time, may check groups, teams, channels, and threads associated with the user for any polls that the user missed during the inactive period. The communication, messaging, conferencing, and collaboration system may then proactively surfaced such polls. The communication, messaging, conferencing, and collaboration system may check for only polls that are still “live” or “not yet close;” or the communication, messaging, conferencing, and collaboration system may check for any polls that the user missed. In some examples, the communication, messaging, conferencing, and collaboration system may check all the groups, teams, channels, and threads associated with the user for any polls that the user previously engaged; the communication, messaging, conferencing, and collaboration system may automatically display an update to the user if a specific status change condition of the poll is met, such as poll is now closed or questions got updated/modified.

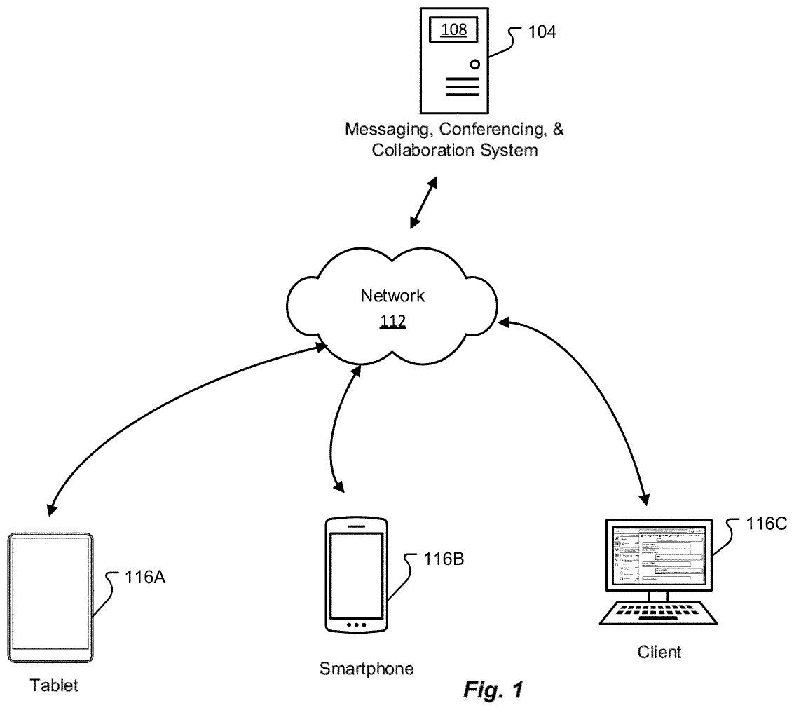

FIG. 1 depicts aspects of a communication, messaging, conferencing, and collaboration system 104 in accordance with examples of the present disclosure. The messaging, conferencing, and collaboration system 104 may include a messaging, conferencing, and collaboration system 108; the messaging, conferencing, and collaboration system 108 may reside at a single device, such as a server of the messaging, conferencing, and collaboration system 104, or may be distributed amongst a plurality of servers and/or other devices for instance. In some examples, the conferencing, messaging, and collaboration system 108 may reside in a cloud environment and may be accessible via one or more networks 112 by one or more devices 116A-116C. In some examples, the client device 116A-116C may correspond to a tablet device 116A, a smartphone 116B and/or a tablet 116C. As another non-limiting example, at least one client device 116A-116C may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (IOT) devices.

As indicated above, one or more devices 116A-116C may interact with the conferencing, messaging, and collaboration system 104. In some instances, a collaboration application, such as Microsoft Outlook or Microsoft Teams may be installed or otherwise executed at one or more of the devices 116A-116C. Alternatively, or in addition, a browser or other network/web accessible application may interact with the messaging, conferencing, and collaboration system 104 via the network 112.

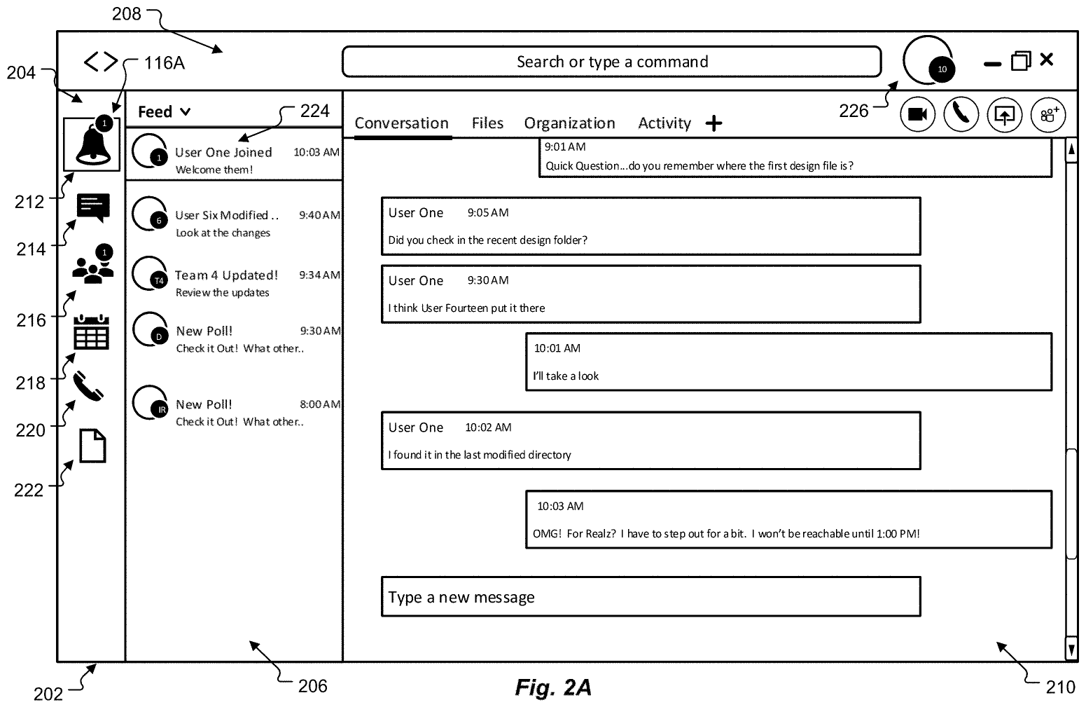

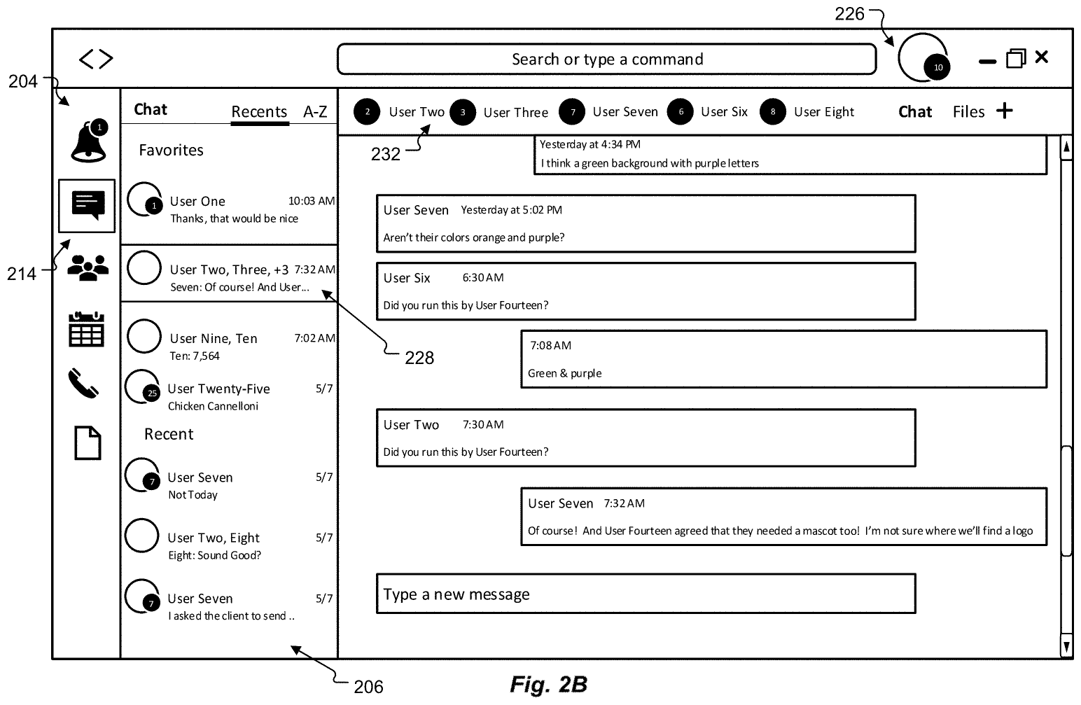

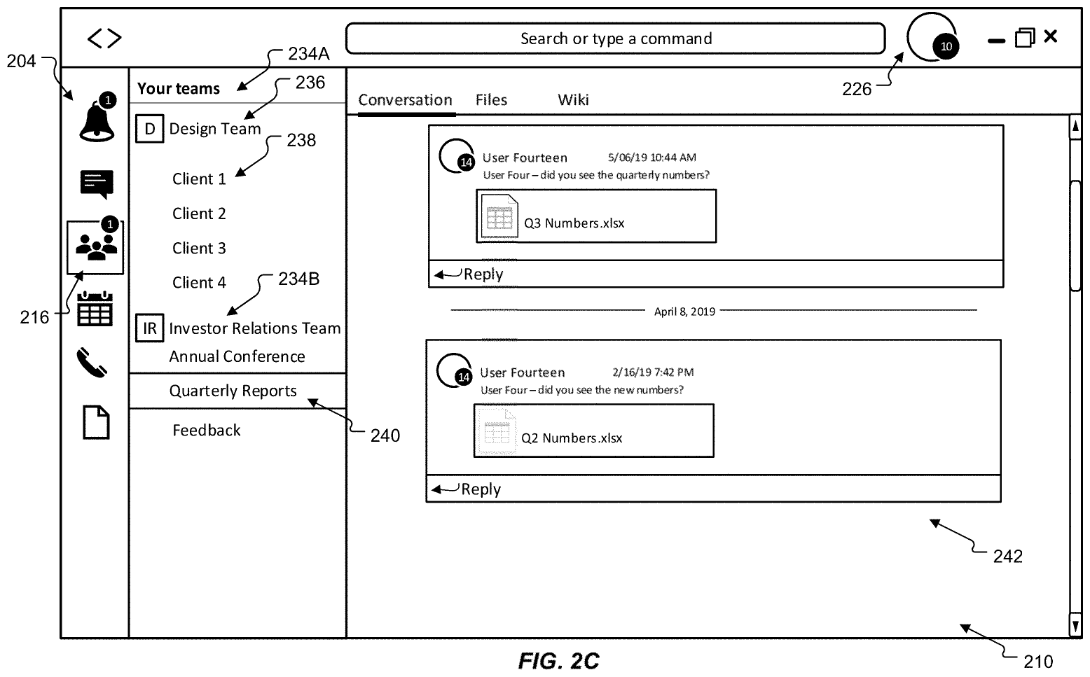

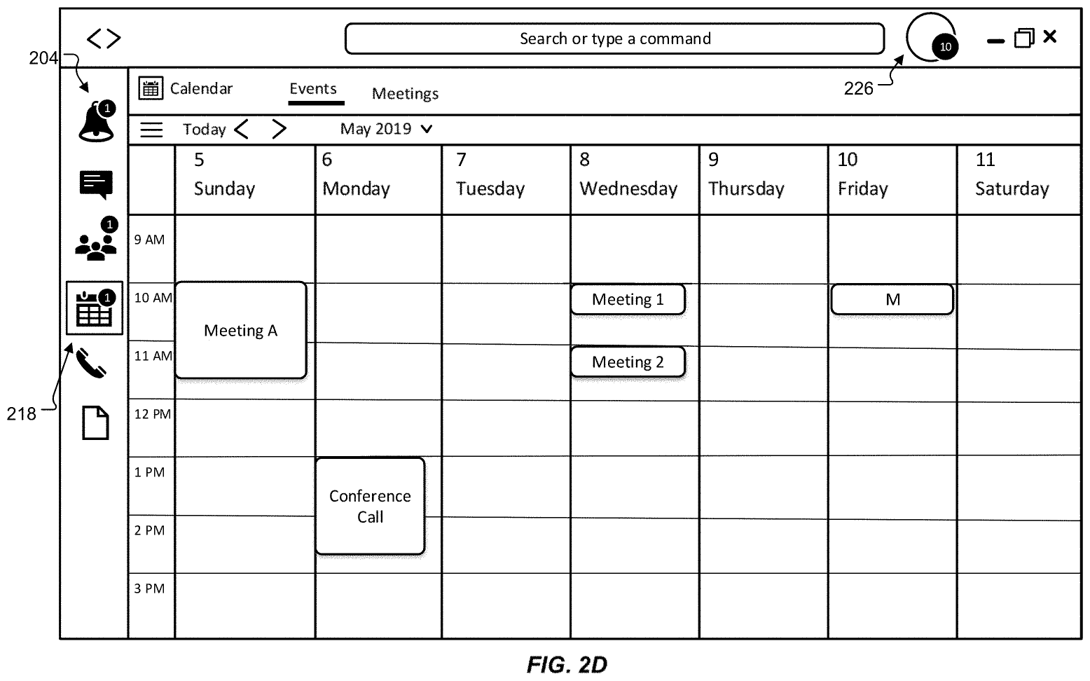

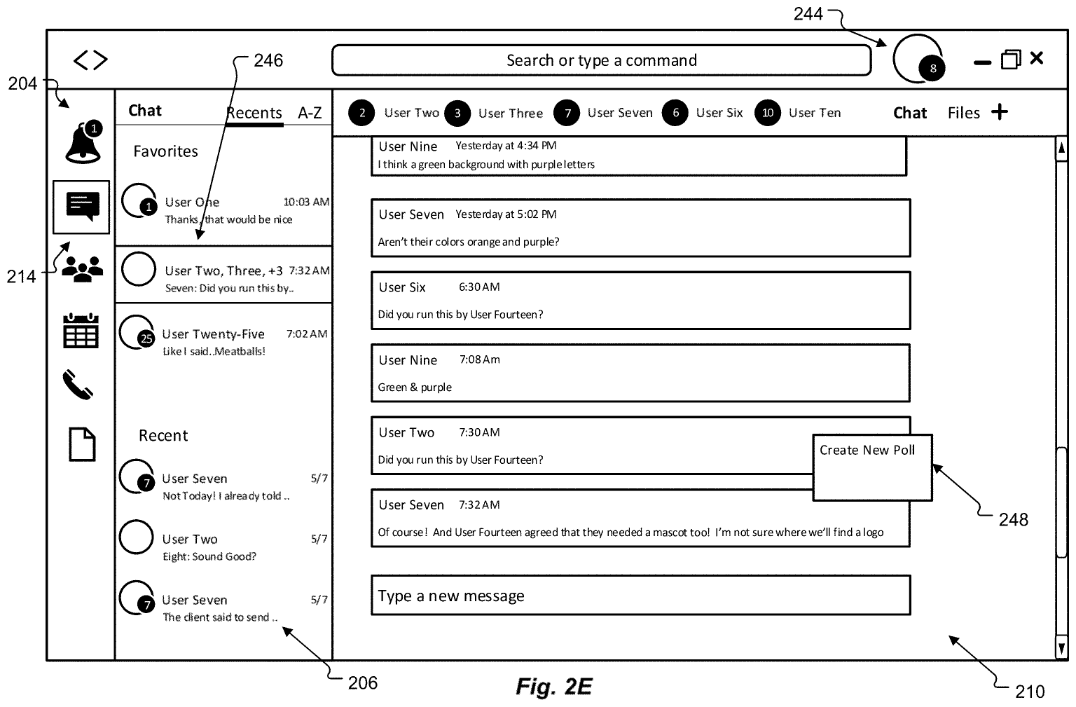

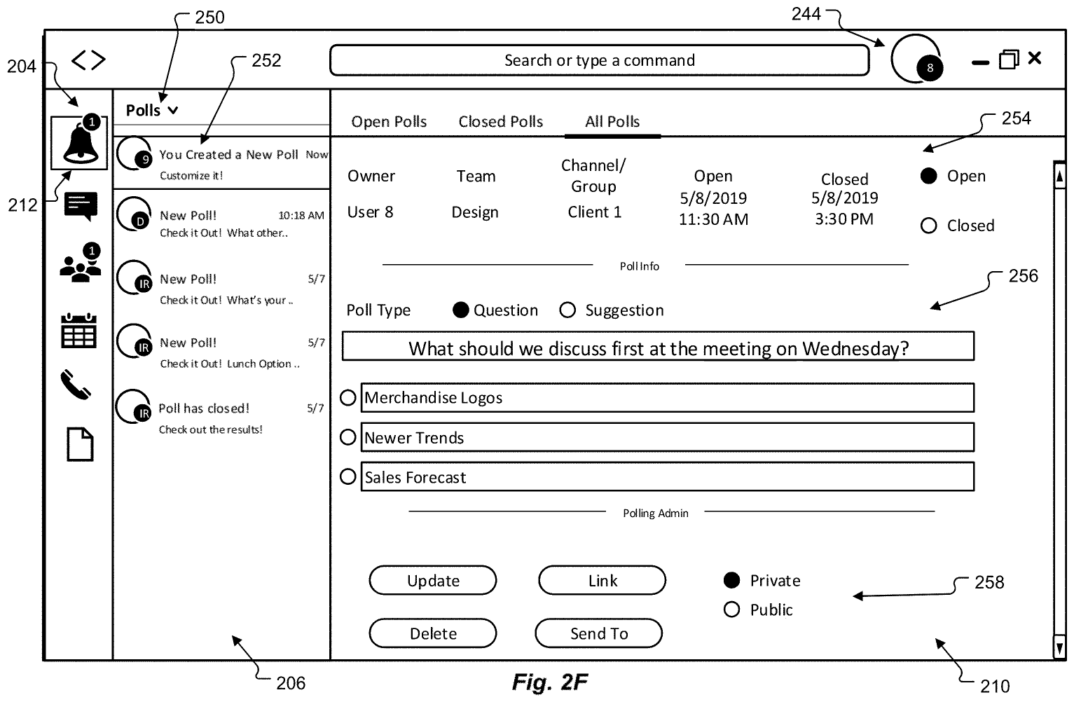

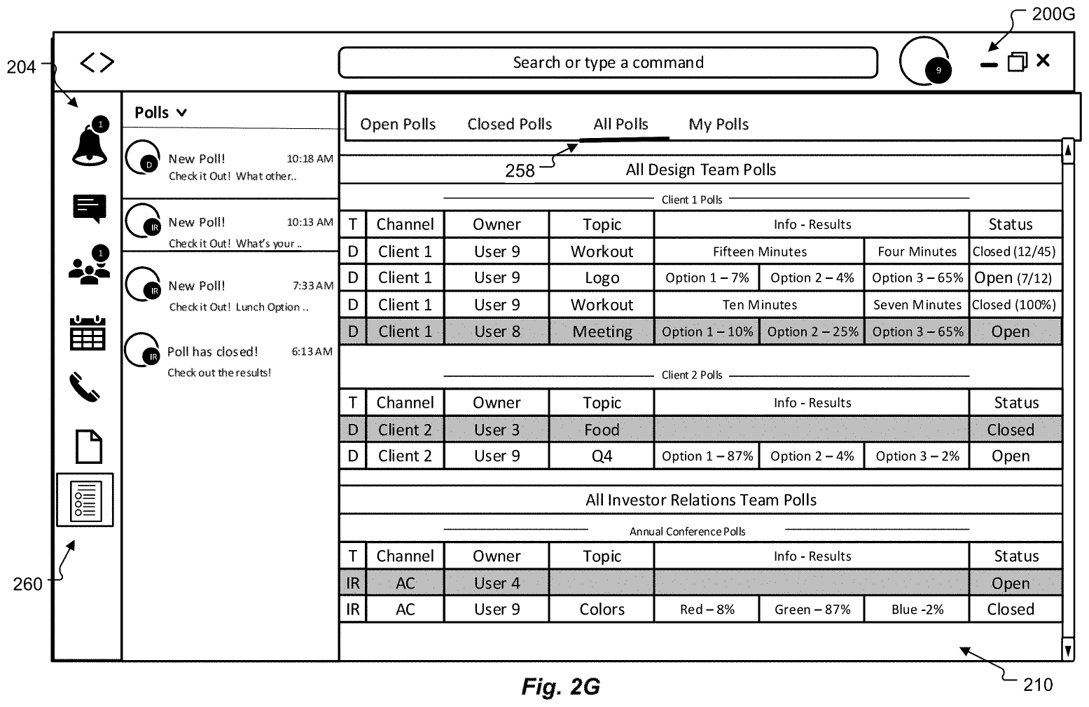

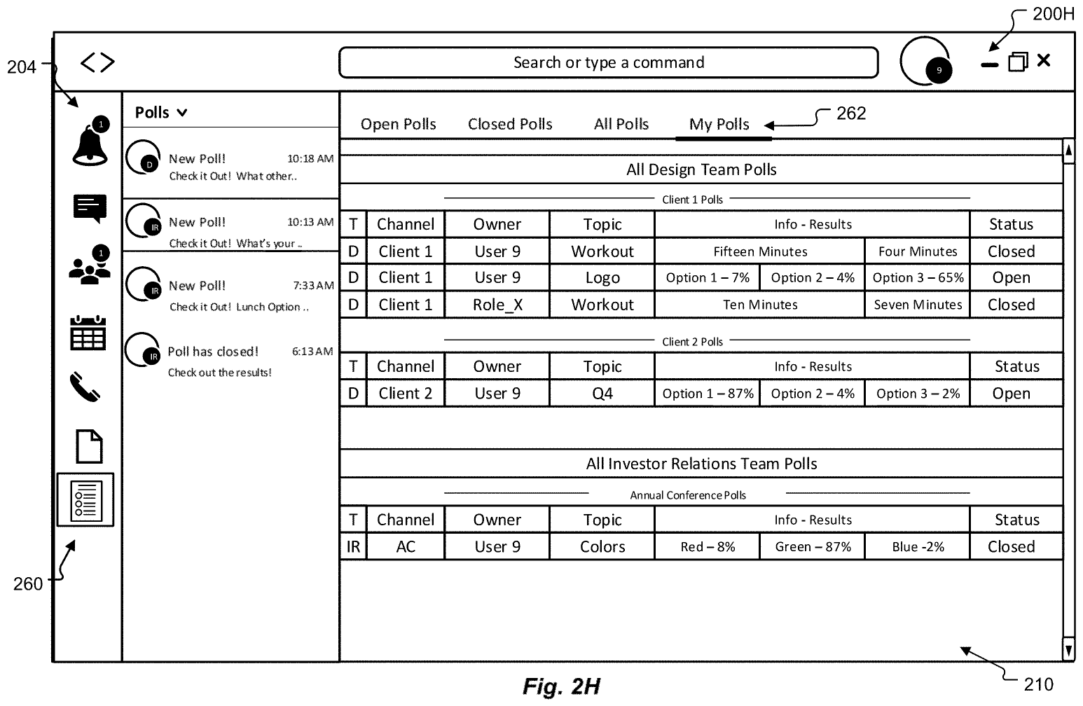

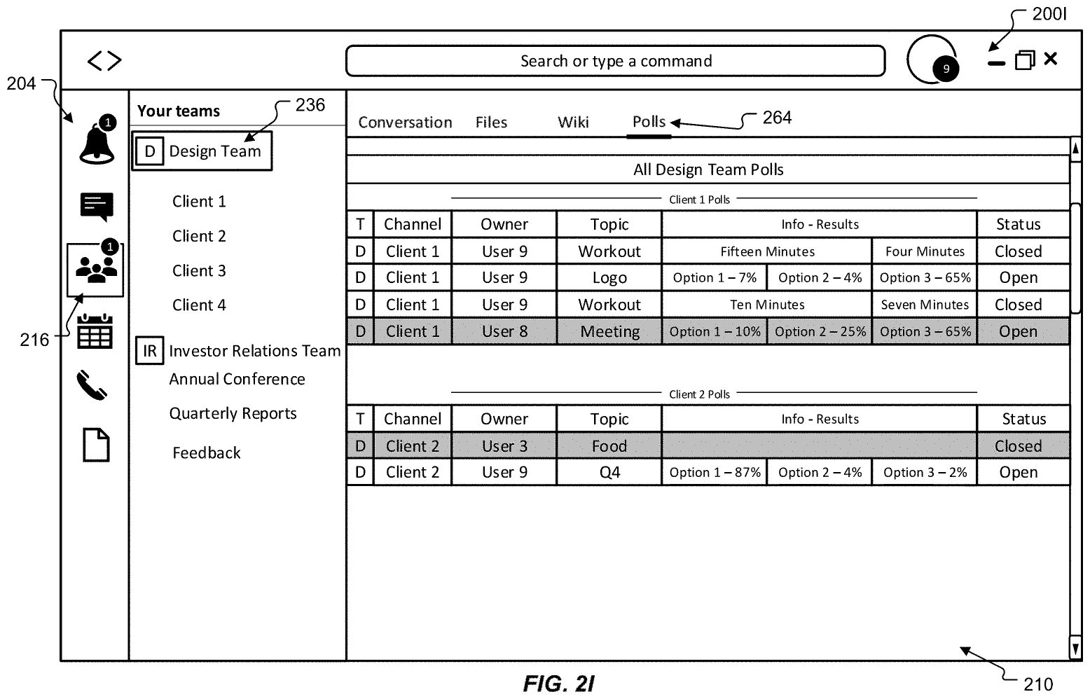

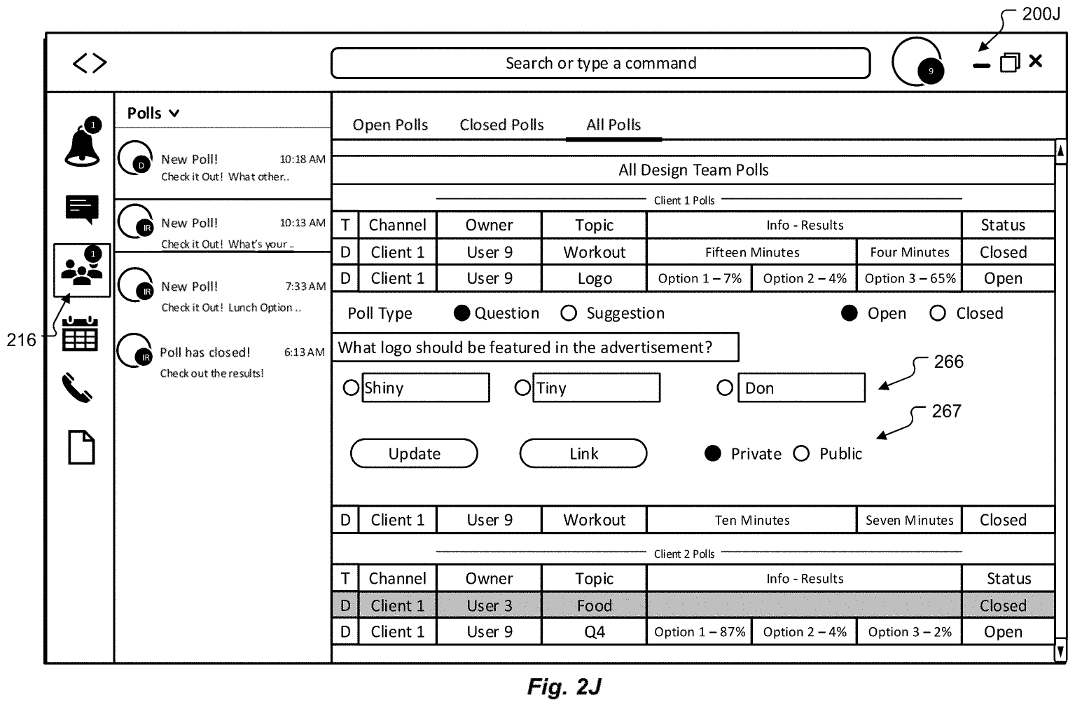

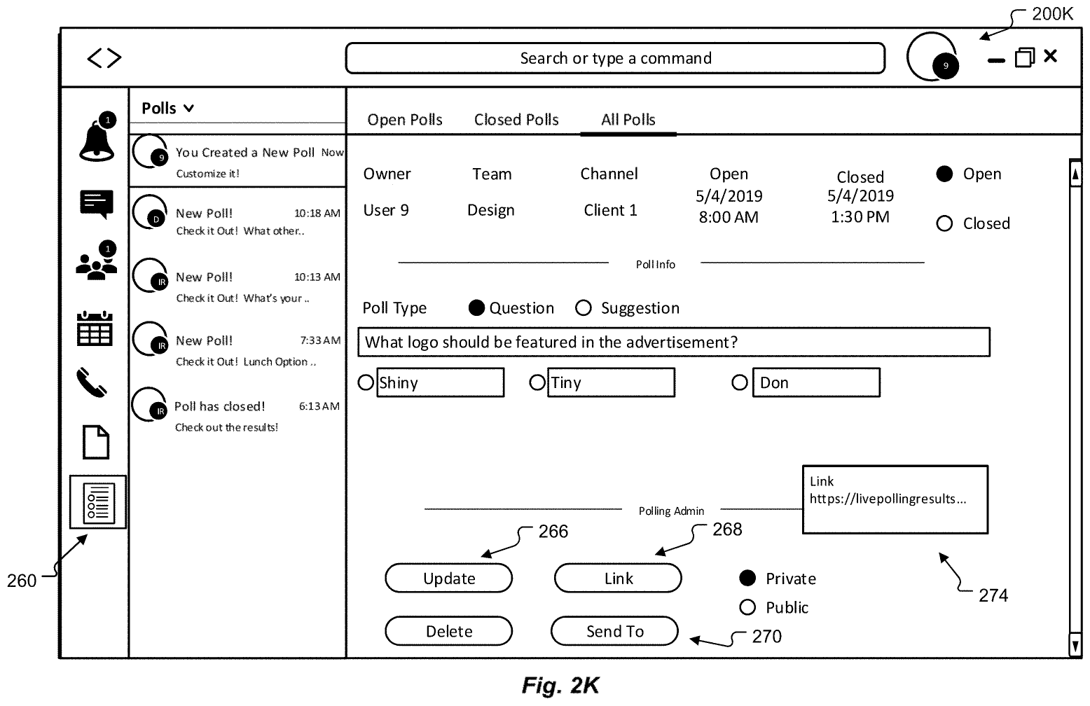

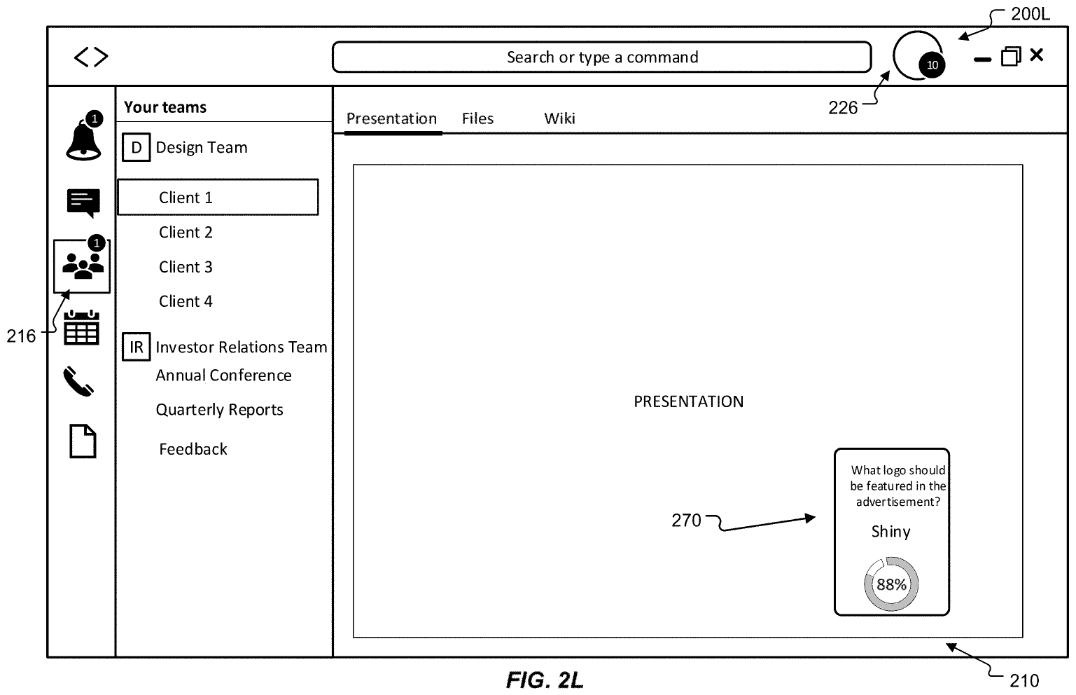

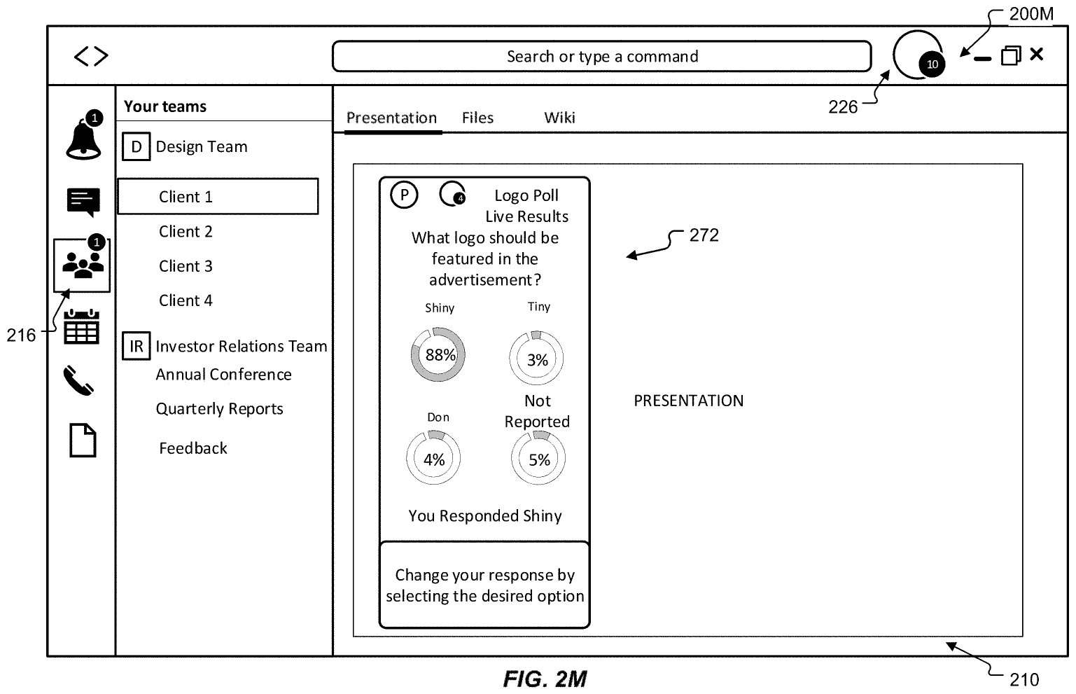

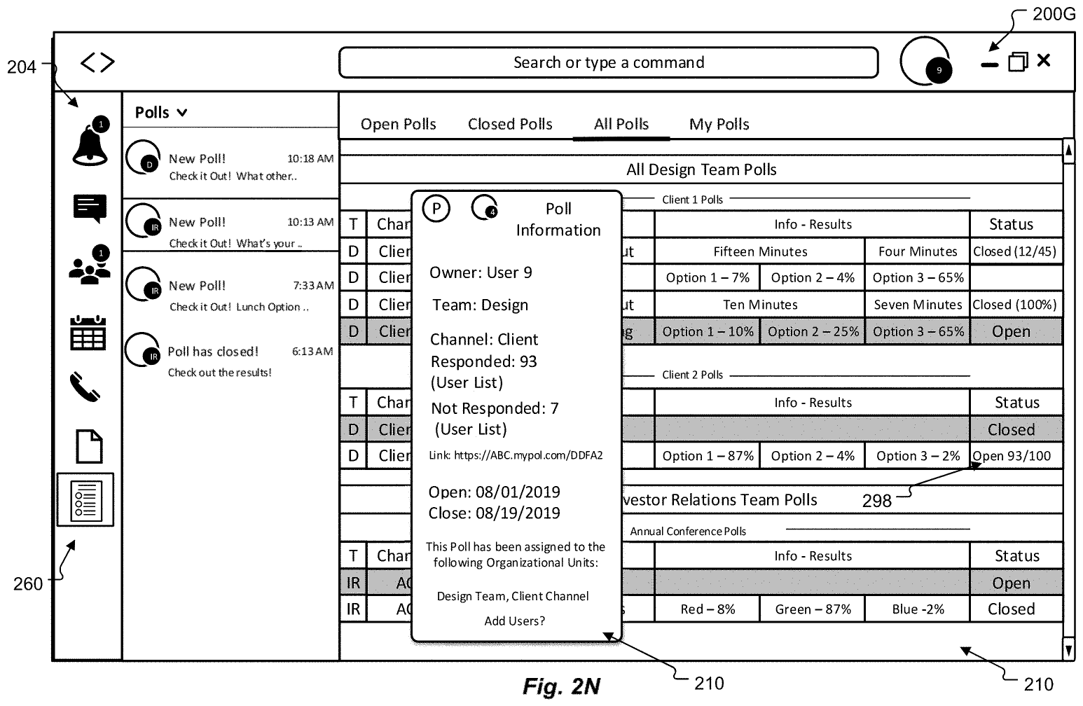

FIGS. 2A-2N provide example graphical user interfaces 200A-L that may be rendered at a user interface of one or more device 116A-C, where the conferencing, messaging, and collaboration system 104 may cause such graphical user interfaces 200A-N to be rendered. Each of the example graphical user interfaces 200A-N may be divided into to one or more areas, or portions that display information associated with a user and/or allow a user to interact with such information. For example, the graphical user interface 200A-N may include a command bar portion 204, a feed or channel portion 206, a header portion 208, and and/or a channel tab portion 210. While the example graphical user interfaces 200A-N are depicted having the command bar portion 204, the feed or channel portion 206, the header portion 208, and/or the channel tab portion 210, it should be appreciated that the graphical user interfaces 200A-N may include additional or fewer portions and/or may be arranged, configured, and/or positioned in a different manner than that which is illustrated in the graphical user interfaces 200A-N.

The command bar portion 204 may include one or more areas specific to selecting an application, app, script, or view to be provided in the feed or channel portion 206 and/or the channel tab portion 210. That is, the command bar portion 204 may include a plurality of icons which when selected, may cause a corresponding view and/or information of a corresponding view to be provided or displayed in the feed or channel portion 206 and/or the channel tab portion 210. For example, when an activity icon 212 is selected, one or more of user, team, or group activity information may be displayed in the feed or channel portion 206 and/or the channel tab portion 210. Such user, team, or group activity information may be filtered and/or displayed based on a current user logged into or otherwise utilizing the one or more graphical user interfaces 200A-N. In addition, the activity icon 212 may dynamically change to indicate a number 205 of new activities, some of which may be unseen or unviewed by the user, that may have been added, posted, or otherwise made available to a team, group, channel, thread to which the user belongs or is otherwise associated. As another example, when a messaging icon 214 is selected, one or more messages associated with the user, a group to which the user belongs, a team to which the user belongs, and/or a channel to which the user belongs, may be displayed in the feed or channel portion 206 and/or the channel tab portion 210. Such user, team, or group messaging information may be filtered and/or displayed based on a current user logged into or otherwise utilizing the one or more graphical user interfaces 200A-N. As another example, when a team icon 216 is selected, information associated with one or more teams, groups, or organizational units to which the user may belong may be displayed in the feed or channel portion 206 and/or the channel tab portion 210. Such team information may be filtered and/or displayed based on a current user logged into or otherwise utilizing the one or more graphical user interfaces 200A-N. As another example, when the calendar icon 218 is selected, information associated with a calendar application and/or a calendar view graphically depicting one or more events, meetings, or other scheduled or to-be-scheduled items may be displayed in the feed or channel portion 206, the channel tab portion 210, or in an area including both the feed or channel portion 206 and the channel tab portion 210. As another example, when the communication icon 220 is selected, one or more options for communicating with another user, such as chat, phone, video conferencing, audio conferencing, etc. may be displayed in the feed or channel portion 206 and/or the channel tab portion 210. As another example, when the files icon 222 is selected, one or more files associated with the user, group, team, channel, or thread to which the user belongs, or is otherwise associated may be displayed in the feed or channel portion 206 and/or the channel tab portion 210. Such file information may be filtered and/or displayed based on a current user logged into or otherwise utilizing the one or more graphical user interfaces 200A-N.

The feed or channel portion 206 may display one or more feeds, channels, or threads associated with the user, a group to which the user belongs, an organizational unit to which the user belongs, a team to which the user belongs, and/or a thread to with the user belongs or is otherwise associated with. For example, when an activity icon 212 is selected as depicted in the graphical user interface 200A, one or more feeds, or communications associated with the user, may be displayed in the feed or channel portion 206. Upon selection of a feed by the user, for example 224, additional information and/or details associated with the selected feed 224 may be displayed in the channel tab portion 210. The channel tab portion 210 may display, for example, a conversation, files, an organization, activity, etc. associated with user activity and/or the selected feed 224.

As another example, a history of instant messages, or chats, may be displayed in the channel tab portion 210, where the user is associated with one or more of the instant messages, or chats, in the history of the instant messages. Moreover, the channel tab portion 210 may include a scroll bar such that a user may navigate to one or more other instant messages displayed in the instant message history, or feed. The header portion 208 may include a user avatar 226 which may provide identifying information of the user currently logged into, authenticated with, or otherwise associated with the information displayed in the graphical user interface 200A. For example, User Ten may be a user logged into or otherwise utilizing the graphical user interface 200A; accordingly, messaging information, calendar information, etc. may be displayed or otherwise filtered based on User Ten.

FIG. 2B depicts details of a graphical user interface 200B in accordance with examples of the present disclosure. Information in the graphical user interface 200B may be displayed upon a user selecting the messaging icon 214 of the command bar portion 204. Accordingly, the feed or channel portion 206 may display one or more conversations, threads, or instant messages associated with the user, for example User Ten. That is, similar to the activity information previously described, the feed or channel portion 206 may display one or more instant message communications associated with a user. Upon selection by a user, for example if User Ten selected the chat 228, the channel tab portion 210 may display additional information about the selected chat 228. For example, the channel tab portion 210 may display or otherwise identify the users 232 that have been involved with, part of, or otherwise contributed to the selected chat 228. The channel tab portion 210 may illustrate or otherwise render one or more instant messages associated with the selected chat 228. Further, a scroll bar may be provided allowing a user, such as User Ten, to view previous messages associated with the selected chat 228.

FIG. 2C depicts details of a graphical user interface 200C in accordance with examples of the present disclosure. Upon selection of the team icon 216, information associated with one or more teams or groups to which the user may belong may be displayed in the feed or channel portion 206 and/or the channel tab portion 210. For example, the feed or channel portion 206 may display a Design Team 236A which may be subdivided into one or more sub-teams, channels, groups, or threads 238. One or more of the sub-teams, channels, groups, or threads 238 may be associated with the user, User Ten. As another example, an Investor Relations team 234B may be displayed along with sub-team, subgroup, channel, or thread 240. Upon selection of the sub-team, channel, group, or thread 240, the channel tab portion 210 may display additional details associated with the selected sub-team, subgroup, channel or thread. For example, one or more reports uploaded by User Fourteen may be displayed in an area 242. As can be appreciated, the reports themselves may be messages or otherwise may include communications and/or comments from one or more users.

FIG. 2D depicts details of a graphical user interface 200D in accordance with examples of the present disclosure. Upon selection of the calendar icon 218, a calendar view depicting one or more events, meetings, or items of a user's schedule may be displayed. The calendar view may depict meetings, events, conference calls, etc. and may be organized according to date, time, event type (meeting, event, calls etc.). As can be appreciated, the items depicted in the calendar view may originate from or otherwise be pulled from one or more data sources storing such scheduled items. As further depicted in FIG. 2D, the calendar icon 218 may change or otherwise be dynamically updated to reflect any new events, meetings, etc. that may have been added to a user's calendar which the user may or may not have previously viewed or seen.

In accordance with examples of the present disclosure, a user, such as User Eight, may wish to solicit information from one or more users. Thus, the communication, messaging, conferencing, and collaboration system 104 may provide the ability for one or more users to create a poll, or survey, to obtain or otherwise gather information from one or more users. A poll is generally used to ask one simple question while a survey is generally used to ask a wide range of multiple questions. A poll, or survey, may be created at any point and/or at any time when a user interacts with the graphical user interface, such as the graphical user interfaces 200A-200D as previously described as well as graphical user interfaces 200E-200L. For example, during an instant messaging session, such as a selected instant message chat 246, a user, such as User Eight (244) may decide to create a poll to collect information from the users participating in the selected instant message chat 246. In some non-limiting examples, the poll or survey may collect information from users grouped by a specified team, channel, group, sub-group, chat, or thread. A user may initiate the creation of a poll, or survey, by right-clicking in the area 248 and selecting Create New Poll. As another example, a user may select a menu drop down from the graphical user interface 200E.

FIG. 2F depicts additional details related to the poll, or survey, creation process. For example, poll related information 254 may be displayed and may indicate an owner of the poll (User Eight), a team to which the poll has been assigned (e.g., the Design Team), one or more channels that the poll may be associated with or otherwise assigned to (e.g., Client 1), and an open or start time of the poll and a close or end time of the poll. Such features may be selected by the user during a poll configuration process. The user may also select a type of poll, such as a question or suggestion, where a question would solicit feedback from the user and a suggestive poll may provide one or more suggestions based on information in one or more feeds, teams, polls, channels, or groups. As further depicted in the graphical user interface 200F, the user may configure the poll such that the poll is private or public utilizing the public/private indication 258, as well as provide additional options specific to one or more administrative features of the poll. Upon creating the poll utilizing the create button 257, the poll, or survey, may assigned to the selected or otherwise designated users and may be open for accepting results, or soliciting information from the one or more designated users between the start and end times of the poll.

Although the graphical user interface 200F displays details of the poll creation process, the graphical user interface 200F may also display information according to a selected view of the user. For example, a user may have the option to display all polls 255, closed poles, and/or just open poles. Thus, the user may be able to select one or more polls to provide information and/or edit a poll which the user previously created or otherwise possess credentials to do so. Further depicted in the graphical user interface 200F, a list of activities associated with a polling creation process may also be displayed in the feed or channel portion 206.

FIG. 2G depicts details of a graphical user interface 200G in accordance with examples of the present disclosure. As depicted in FIG. 2G, the creation of the poll by User Eight for example, may be associated with or otherwise with or otherwise tied to a specific channel, team, and/or group. The graphical user interface 200G may be commonly referred to as an administrative user interface where polls associated with a team, channel, group, or organizational unit may be displayed. In one example, a user such as User 9 may select a polling administrative icon 260 in the command bar portion 204. Upon selection of the administrative icon 260, the channel tab portion 210 may display a plurality of polls grouped in accordance with one or more organizational units. For example, if User 9 were to select an “All Polls” option or filter 258, all polls which the User 9 is associated with may be displayed in a single location, such as the channel tab portion 210. In some examples, distinguishing indicia may be utilized to highlight those polls owned by the user, for example User 9. Poll ownership may allow a user to select, modify, and/or cancel one or more polls. Moreover, organizational unit access and control rights may be inherited in a hierarchical manner such that an admin of a team or group may also be admin of a channel, thread, or other organizational unit, allowing such user the ability and access to change, modify, and/or cancel one or more polls created by other users. In addition to grouping the polls by one or more organizational units, for example by client and/or team as depicted in FIG. 2G, the administrative user interface 200G may further provide poll related information, such as a team to which the poll is assigned, a channel to which the poll is assigned, an owner of the poll, a topic of the poll, a status of the poll, and results, if any, of the poll in a summary view.

FIG. 2H depicts details of a graphical user interface 200H in accordance with examples of the present disclosure. As depicted in FIG. 2H, a user may select a filter or option 262 to display only those polls which the user is an owner of. Similar to the graphical user interface 200G, the graphical user interface 200H may group the polls by one or more organizational units, such as a team, a group, channel, thread etc. FIG. 2I depicts details of a graphical user interface 200I in accordance with examples of the present disclosure. As depicted in FIG. 2I, a user may select a team icon 216 from the command bar portion 204. In response to the selection of the polls option or filter 264, the polls associated with the selected team may be displayed. In instances where one or more groups, channels, organizational units, threads, or organizational units may exist within the selected team, for example the “Design Team” 236, the polls displayed in the channel tab portion 210 may be organized by such groups, channels, organizational units, threads, or organizational units. Similar to the graphical user interface 200G, polls in which the user is not an owner may be distinguished from polls of which the user is an owner.

FIG. 2J depicts details of a graphical user interface 200J in accordance with examples of the present disclosure. As depicted in FIG. 2J, a user may select a poll to which they are an owner or otherwise have sufficient access rights to be able to edit a poll or are otherwise assigned to a role or assigned a role which has sufficient rights to be able to edit a poll object. For example, a user, such as User 9 may select the poll related to a logo option for an advertisement, as depicted in the graphical user interface 200J. Accordingly, additional information associated with the specific poll may be displayed. For example, a user may be able to change one or more features, options, or values of the poll by selecting and change potential responses 266, and/or by making the poll available to the public vs. being restricted to a private group of individuals 267, such as members of a team, group, thread, or organizational unit.

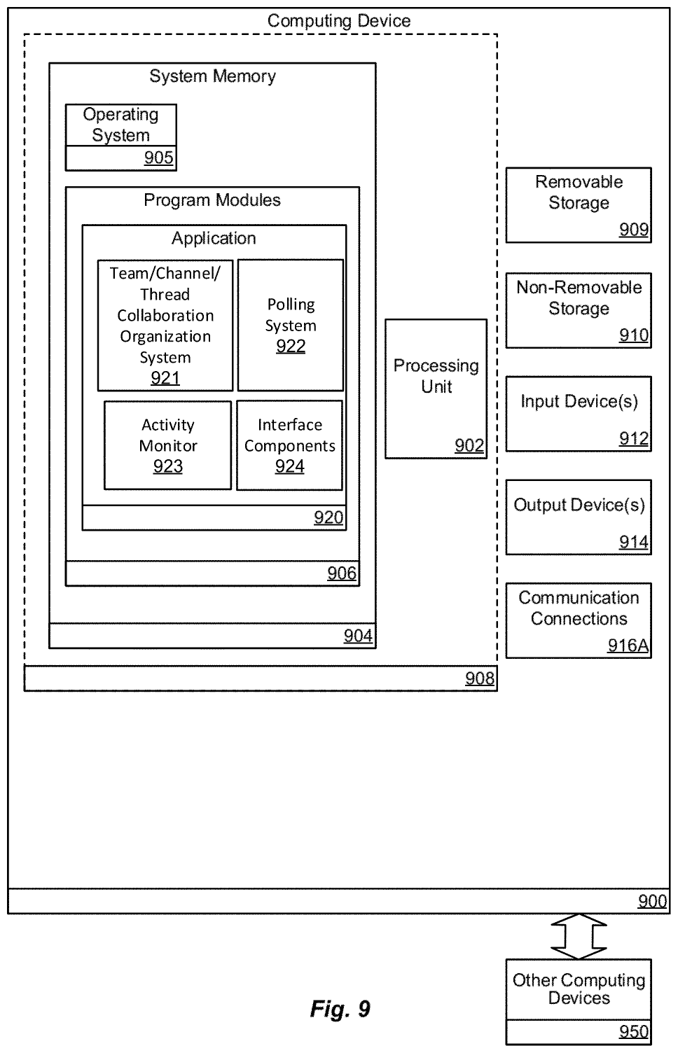

In some instances, and as depicted in FIG. 2K, a graphical user interface 200K may be displayed that provides additional details and/or options with respect to a specific poll. For example, the user may select the poll related to a logo option for an advertisement, as depicted in the graphical user interface 200J. Additional information, such as when the poll opened and when the poll closes or closed may be provided. Further, similar to the graphical user interface 200J, the user may change one or more features, answers, or questions associated with the poll. In some examples, a user may make changes and select the update button 266 to cause the changes to be committed. In some examples, a user may be able to delete a poll. In addition, the polling admin area of the graphical user interface 200K may also provide the option, or ability, for a user to generate a link 274 associated with a specific poll for embedding into a productivity application or display accessible to other users utilizing a generate link 268 option. More specifically, live polling results may be displayed based on the link 268 generated via the user interface 200K. In at least one example, the link 274 may be embedded into a presentation, such as a presentation displayed at the graphical user interface of 200L of FIG. 2L, such that live results 270, or real-time results, of the poll are provided in the presentation. As another example, the live results may display additional information associated with the poll. For example, whereas the graphical user interface 200L displayed a top option in the live results 270, the graphical user interface 200M of FIG. 2M may display all results. Further, and in some instances, a user may be able to change their previously submitted response by clicking on the poll. For example, a user using an application to which one or more access credentials are required may be able to change their previously submitted poll results. Additional details with respect to the link 274 are discussed with respect to FIG. 9.

In some instances, and as depicted in FIGS. 2L and 2M, a link to a poll may be included in a presentation, application, or the like such that an aspect of the poll may be displayed during the presentation, application, or the like. More specifically, a presentation, such as the presentation displayed in FIG. 2L, may include a link to a poll such that a graphical element of live results 270 displays poll information. The poll information may include live or static results and/or other content. For example, as depicted in FIG. 2M, the graphical element 272 may include poll results that breakdown each response. While the poll results are depicted as being one of four answers, the graphical element, the amount of information depicted in the graphical element and the manner in which the information is depicted should not be considered limiting. As previously discussed, the graphical element 272 may include information via a link; that is, a link may be embedded within or inserted into a presentation, application, or otherwise such that the graphical element displays poll related information continuously or at a desired location, such as within a power point application.

In some instances, and as depicted in FIGS. 2N, a hover event may cause an window including an additional information to be displayed. For example, in the graphical user interface 200N, a user may hover on information related to a poll 298. After a passage of time, a graphical element, such as the window 299, may be displayed, where the graphical element may include information such as, but not limited to: an owner of the poll; one or more teams/groups/channels/organizational unit/etc. to which the poll has been assigned; a number users that have responded; a number of user that have not responded; a link to the poll for inserting into an application, document, or presentation; and the ability to add additional user or otherwise assign the poll to additional users. Accordingly, a user may quickly view additional information associated with the poll without clicking on or expanding the poll for additional details.

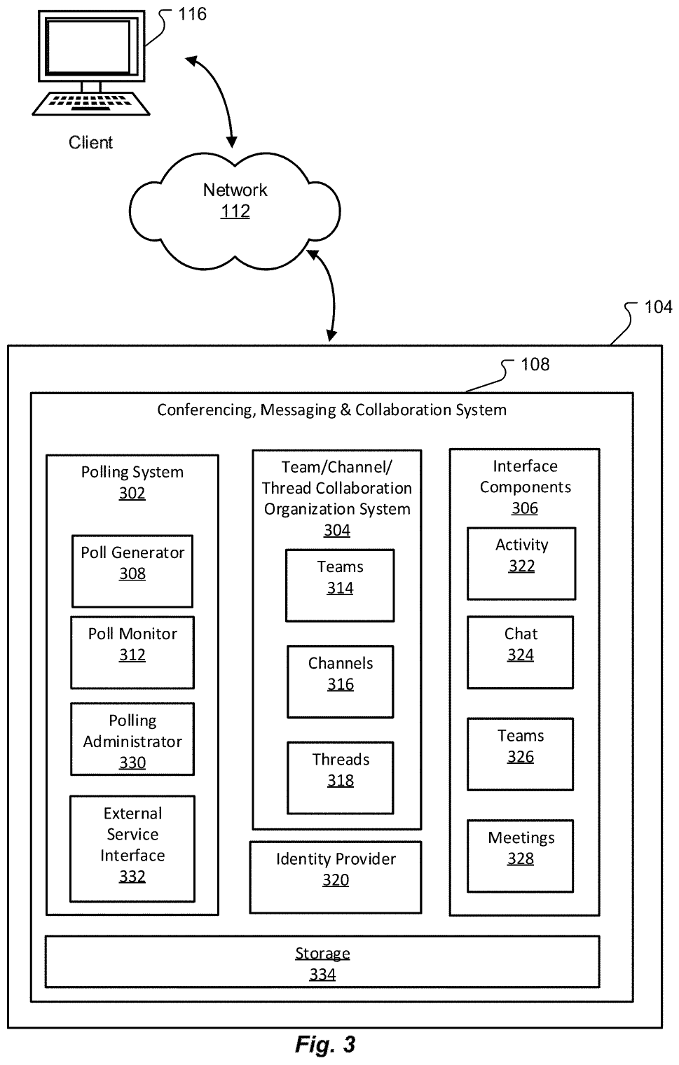

FIG. 3 depicts additional details of the conferencing, messaging & collaboration system 108 in accordance with examples of the present disclosure. More specifically, FIG. 3 depicts a conferencing, messaging & collaboration system 104 which may reside at one or more data processing devices, such as one or more servers or the like, and may include the conferencing, messaging & collaboration system 108 as previously described. The conferencing, messaging & collaboration system 108 may include a polling system 302, a grouping organizational system 304, interface components 306, an identity provider 320, and storage 334. The grouping organizational system 304 generally provides a way to hierarchically organize users, projects, tasks, communications, and user interactions in such a manner so as to foster collaboration and organization in team environments. In accordance with examples of the present disclosure, the grouping organizational system 304 may allow one or more users to be organizationally assigned or otherwise grouped according to one or more teams 314. Further, a user may be grouped or otherwise assigned to one or channels 316, where each channel 316 may include one or more threads 318. Of course, each thread 318 may be further divided if need be as indicated by the ellipses. The interface components 306 generally correspond to the one or more icons in the command bar portion 204 of the graphical user interfaces 200A-M. The interface components 306 generally provide one or more options for allowing a user to interact with the conferencing, messaging, & collaboration system 108. Accordingly, a user may see latest activity utilizing the activity component 322, chat and communicate with instant messages using the chat component 324, change assignments, view documents, subdivide tasks, and manage groupings utilizing the teams component 326, hold meetings utilizing the meetings component 328, and view, track, schedule, and change events, meetings, or other scheduled items utilizing a calendar component 330. The identity provider 320 is generally responsible for determining a user's identity through an authentication process and enforcing one or more access controls for allowing and/or restricting access to one or more groups and/or interface components.

The polling system 302 includes one or more components responsible for implementing polls and/or surveys in accordance with examples of the present disclosure. More specifically, the polling system 302 may include a poll generator 308, a poll monitor 312, a polling administrator component 330, and an external service interface component 332. The poll generator 308 provides the ability for a user to create, management, and assign one or more polls to one or more events, persons, users, and/or objects. For example, the poll generator 308 may generate poll information that is no just accessible to a user, but may be accessible to one or more other components of the conferencing, messaging, & collaboration system 104 such as the polling administrator component 330. In some examples, the identity provider 320 may be relied upon by the polling system 302 to ensure that the correct users have the necessary permissions to interact with a poll or survey. Thus, a user may create a poll and assign the poll to one or more users. The polling system 302 may then communicate with a calendar component to provide one or more portions of the poll information such that a graphical element may be displayed in a user's calendar application and/or calendar view. In some instances, the polling system 302 may provide a start and end time for a poll such that a graphical element may be generated and displayed at a user's calendar application and/or calendar view. In some instances, the polling system 302 may store poll information in a poll storage 334 and provide the calendar component a reference, or link, to the information stored in the poll storage 334.

In some examples, the conferencing, messaging, & collaboration system may include an external service interface component 332 which may communicate with one or more external applications such as a productivity applications, web browsers or the like. The external service interface component 332 may provide a mechanism for allowing linked results of a poll to be included in one or more external applications, web browsers or the like. For example, the external service interface component 332 may control how a link is generated, a duration of time the link may be alive for, and access restrictions, if any, to the link. Accordingly, incoming requests for live poll results may be handled by the external service interface component 332. In some examples, the poll storage 334 may include additional information about the poll, such as results of the poll, live results of the poll, and a link to the poll such that a user can complete or participate in the poll. Accordingly, the external service interface component 332 may access such polling information from the storage 334. Although depicted as residing within messaging, conferencing, and collaboration system 108, it should be appreciated that one or components and/or elements described above may reside outside of but be communicatively coupled to the messaging, conferencing, and collaboration system 108.

The poll monitor 312 may monitor which users have responded to a particular poll. For example, if a group to which a first user belongs was assigned a poll, and/or if the user was directly assigned a poll, the poll monitor 312 may determine whether the user responded to the poll. Thus, the poll monitor may track which users have responded and which users have not responded. The polling administrator component 330 may handle one or more administrative functions or roles associated with a poll. For example, the polling administrator may determine which user has access to change which features of a poll based on identity information from the identity provider 320 as well as hierarchical access restrictions that may naturally flow from a team, group, channel, thread, or other organizational unit. The one or more access controls for allowing and/or restricting access to one or more groups and/or one or more interface components may also depend on a role assigned to a user. For example, a role may determine what permissions and/or what access a user has within or for another object. In some examples, the role may before an organizational unit and/or for a component of the organizational unit. For example, a user assigned to a team may be assigned to a team role providing the user access to one or more areas of the team but may restrict the user from adding content and/or creating polls. In some examples, a user may be assigned multiple rolls. The role may dictate which users have access to which resources and how such resources may be utilized; a role may dictate which resources have access to which users how the resource can interact with the users. As one example, the ability for a user to access a poll to modify questions, answers, results, an open time, a closed time, or other poll related information may depend on whether a user has been assigned to a role that has sufficient privileges and/or access rights to perform such modification. Similarly, the ability for a user to access a poll to provide a link to a poll and/or insert a link into a presentation may depend on whether a user has been assigned to a role that has sufficient privileges and/or access rights to perform such features. In some examples, a modification of a poll and/or access to a graphical element may depend on whether a user has sufficient privileges and/or access rights for the window to be surfaced in front of a user and/or how the window can or is presented.

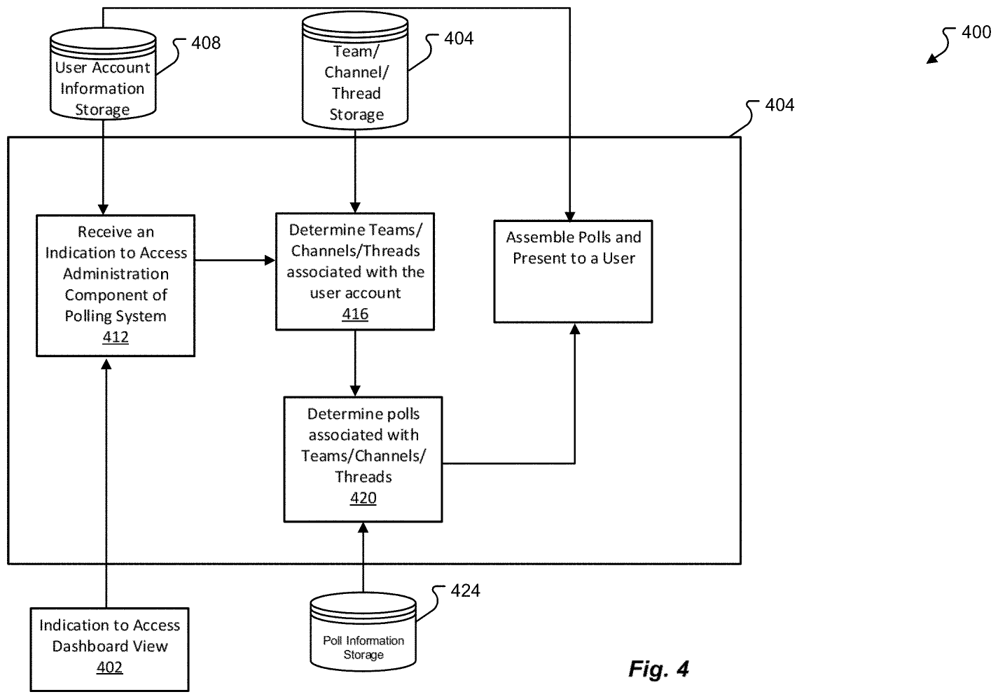

FIG. 4 depicts additional details directed to determining information for display at a dashboard view consolidating all the polls invoked by the user and/or associated with each “team” or “channel” associated with that user. More specifically, a processing device, such as the messaging, conferencing, & collaboration system may perform such features of FIG. 4. Account information associated with a user may be stored in storage area 408. An indication 420 to access a dashboard view, and in some instances, an administration component of a polling system may be received at 412, where together with the user account information, one or more teams, channels, threads, or other organizational units may be determined to be associated with the user. Accordingly, from the team, channel, thread, organizational unit thread storage 404, one or more polls may be determined based on user and team, channel, thread, organizational unit at 416. That is, a poll may be associated with an organizational unit and/or role and not specifically with a user, and a user may be associated with an organizational unit but not specifically with a poll. Accordingly, the poll information storage 424 may provide poll related information for determining which organization unit, and therefore user, is associated with the poll. Moreover, the poll information storage 424 may provide one or more polls or one or more roles of one or more polls that may be required for accessing information associated with a specific poll. For example, poll information from poll information storage 424 may require a user to be assigned a roll having view and/or edit rights such that a user can view and/or edit a poll. For instances where a user may be associated with multiple polls, the plurality of polls may be accessed and assembled into a view to be presented to the user. For example, as depicted in FIG. 2H, polls associated with a user may be provided to a user interface. As depicted in FIG. 2G, a user may have view rights for other polls not specifically assigned to or created by the user.

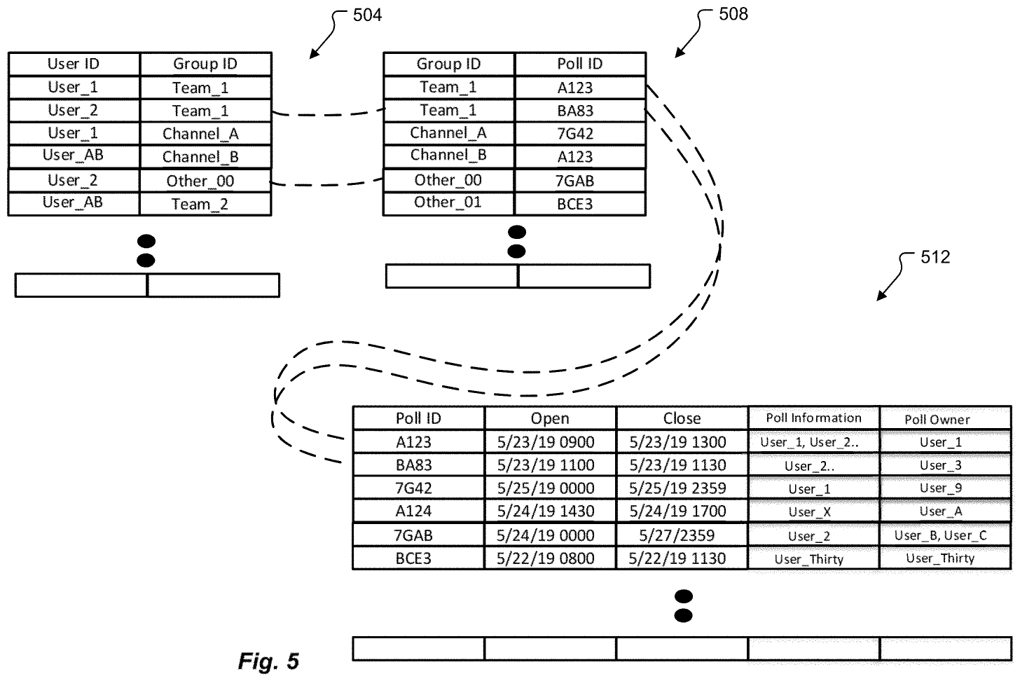

FIG. 5 depicts one or more data structures illustrating user and group poll assignments in accordance with examples of the present disclosure. A first data structure 504 may associate a user to one or more groups, organizational units, and/or roles, such as a channel, team, group, thread etc. As used herein, an organizational unit may refer to a group, channel, team, thread, and/or communication. An organizational unit may provide a manner of grouping objects, such as user accounts, and hierarchically managing permissions associated with one or more objects, such as a team, channel, or thread. Based on the group ID, one or more polls assigned to the group may be stored in a data structure 508 for example. Additional poll information, for example an open or start time, a close or end time, and one or more users who have viewed such information, may be stored in the data structure 512. The data structure 512 may store one or more poll owners associated with a poll identifier in addition to open/close times. Accordingly, upon retrieving information, and more specifically, poll information, for display at a dashboard view, the poll owner may be displayed as well as the ability to edit one or more portions of the poll may be limited by ownership. In some instance, the poll owner may be associated with a poll own roll.

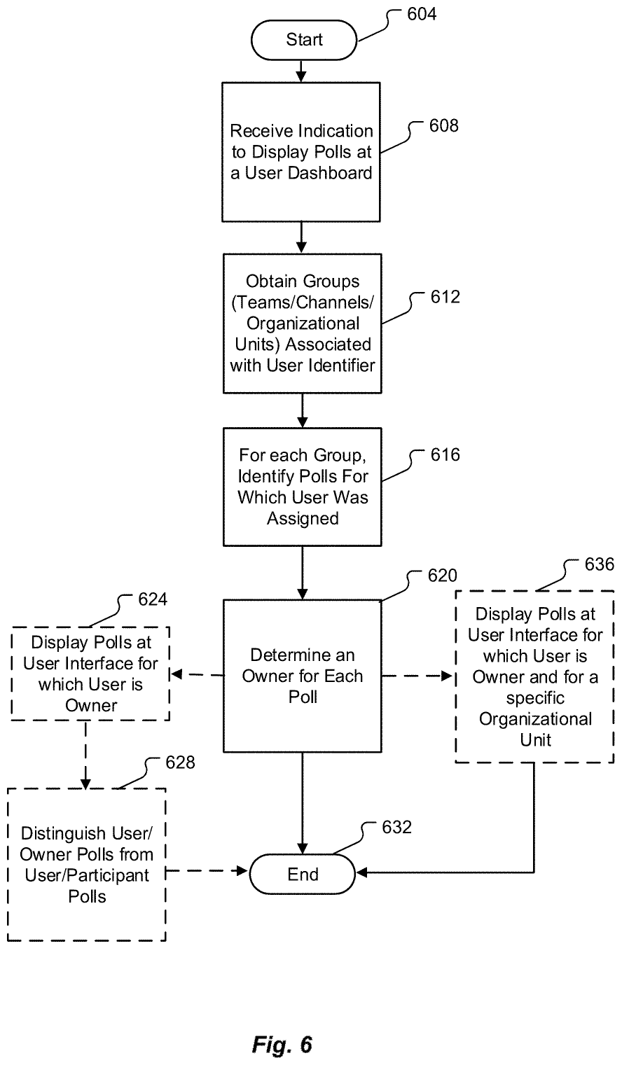

FIG. 6 depict details of a method 600 for determining poll related information to provide to a user in a dashboard view in accordance with examples of the present disclosure. A general order for the steps of the method 600 is shown in FIG. 6. Generally, the method 600 starts with a start operation 604 and ends with the end operation 632. The method 600 may include more or fewer steps or may arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIGS. 1-5.

The method 600 starts at 604 and proceeds to 608, where an indication to display poll information associated with a user in a dashboard view of a user interface is received. For example, a user may click on an option to view all polls assigned to the user, to view all polls created by the user, and/or view all polls to which the user has been assigned access rights or otherwise is associated with a role having such access right. The access rights may allow the user, or role, to view and/or edit one or more aspects of a poll. At 612, the groups, or organizational units for example, associated with the user may be retrieved/received. For example, an organizational unit may be assigned to a group or a group may be assigned to a user. Alternatively, or in addition, a group and/or a user may be assigned to a role, the role being the same or different role. At 616, based on polls having been assigned to organizational units, polls assigned to groups to which the user is a member or otherwise has been assigned may be obtained. In some instances, all polls associated with a group in which the user is a member or otherwise has been assigned may be obtained. For example, some polls where a user does not have sufficient rights, access, or otherwise or has not been assigned to a specific role, such as a role providing view access, may not be retrieved. In instances where polls are filtered based on owner and/or displayed based on owner, an ownership of each polls may be obtained at 620. That is, polls that were created or otherwise “owned” by a user may be displayed at a dashboard view and/or distinguished from other polls at the dashboard view.

At 624, poll information associated with each poll may be displayed or otherwise caused to be displayed at a graphical user interface. For example, poll information may be provided in a table view such as that depicted in FIG. 2H. The poll information may include that which has been previously described and/or depicted, or may include other information related to the polls, such as but not limited to how many users have responded, how much time available to respond before the poll closes, etc. In some instances, and at 628, polling information for polls owned by the user may be displayed in a manner different from poll information for polls not owned by the user. For example, as depicted in FIG. 2G, non-user owned polls may be displayed without shading or other indication. In some instances, the user owned polls may be displayed with shading and the non-user polls may be displayed without shading. The method may end at 632. In some examples, a dashboard view may depict or otherwise group polls by an organizational unit to which the polls belong. For example, poll information may be filtered, sorted, or otherwise listed by a team, or other organizational group assignment as depicted in FIG. 2H. In some instances, where an organizational unit includes a subgroup, such as but not limited to, one or more threads, groups, channels, or other organizational unit, the polls may be displayed at a dashboard view where such poll information is grouped by subgroup.

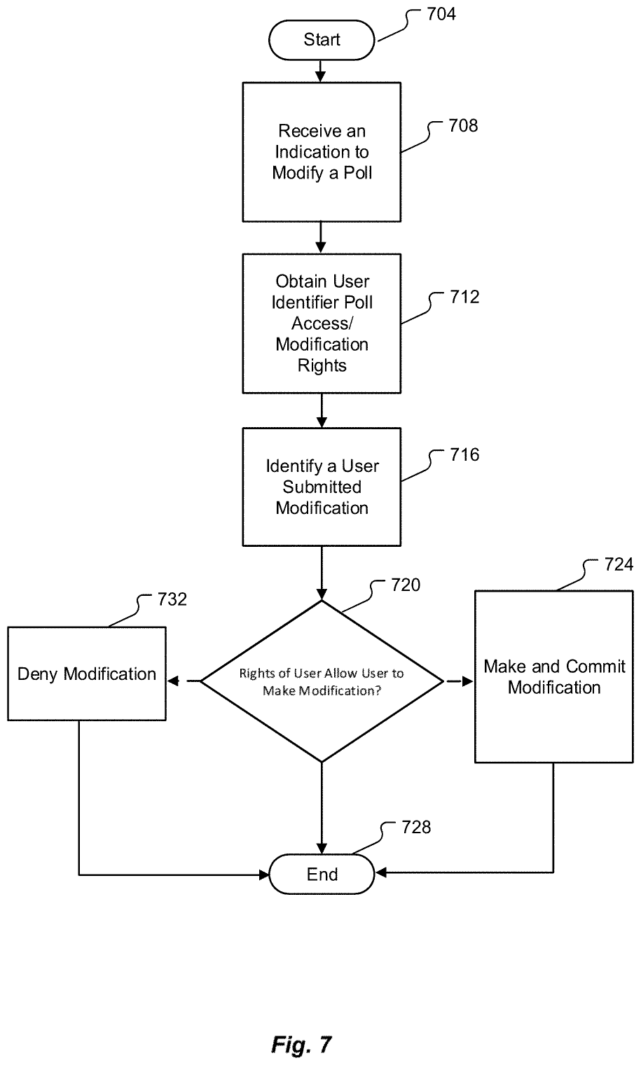

FIG. 7 depict details of a method 700 for allowing a user to make a change or modification to a poll that has been previously created. A general order for the steps of the method 700 is shown in FIG. 7. Generally, the method 700 starts with a start operation 704 and ends with the end operation 728. The method 700 may include more or fewer steps or may arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, Application Specific Integrated Circuit (ASIC), a field programmable gate array (FPGA), a system on chip (SOC), or other hardware device. Hereinafter, the method 700 shall be explained with reference to the systems, components, modules, software, data structures, user interfaces, etc. described in conjunction with FIGS. 1-6.

The method 700 starts at 704 and proceeds to 708, where an indication to modify a poll may be received. For example, a user may click on poll information displayed in a dashboard view, as explained with respect to FIG. 2J. For example, upon clicking on poll information, or clicking into the poll, additional information may be displayed, such as the poll type, poll question, poll answers, and/or one or more other configurable and non-configurable options associated with a poll. As the indication may be received at 708, rights associated with the user may be obtained at 712. For example, rights pertaining to a specific organizational unit of which the user and/or the poll belong may be obtained. In some instances, the rights may be inherited or otherwise obtained from a group or organizational unit encompassing an organizational unit or group. In some instances, a role associated with the poll, group, organizational unit, and/or the user may determine whether a user has rights to edit, change, modify, or delete a poll.

A user may desired to create a modification; the modification may be received at the user interface at 716, for example, a user may change a name, property, time, etc. of an item displayed at the user interface of 200J. Although user interface 200J depicts various options for changing one or more features associated with a poll, such displayed features should not be considered limiting. At 720, the method may determine whether the user has or otherwise has been assigned sufficient rights to modify an existing poll. In some instances, a user may belong to a group or otherwise be assigned to a role which has rights to edit but not delete a poll; in some instances a user may belong to a group or otherwise be assigned to a role that has complete control over polls, such as an administrative group; in some instances, a user may be belong to a group or otherwise be assigned to a role that has no ability to edit a poll, even if a user created the poll. Accordingly, some users may be able to edit polls which were not created by the same user that created the poll. Thus, the method 700 may proceed to 724 where a change may be made and then committed. A commitment of a change generally indicates that a change has been accepted, for example at a user interface, and stored at a storage location such that future invocations of the feature changed reflect that the change has occurred. The method 700 may end at 728. In instances where a user does not have correct or sufficient rights to modify or otherwise make a change to the poll, the modification request may be denied at 732.

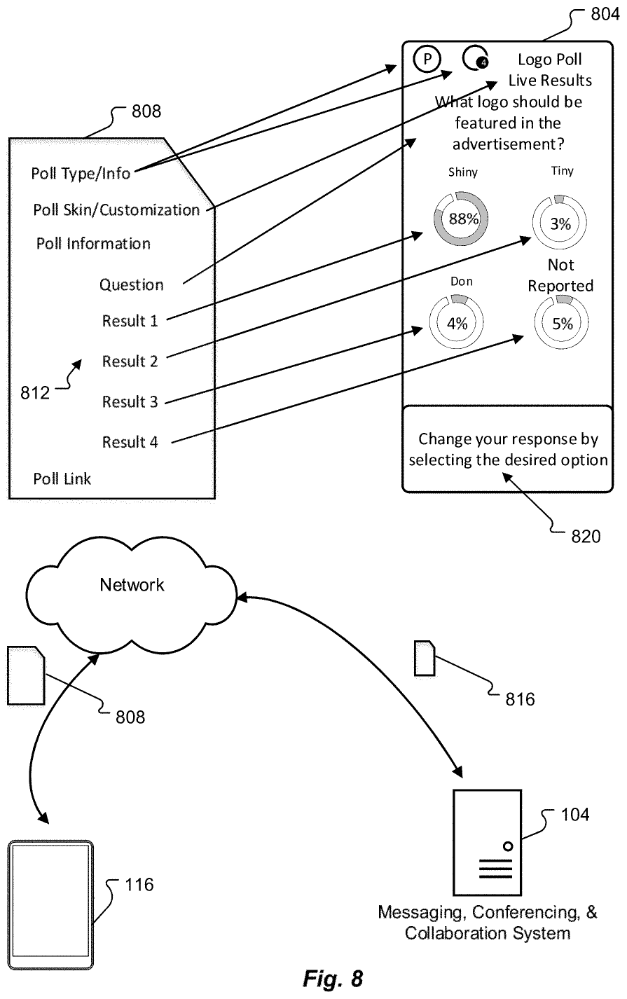

FIG. 8 depicts an example of a poll wrapper 808 for sending/receiving information about a poll, such as poll 804, in accordance with examples of the present disclosure. The poll wrapper 808 may correspond to poll 804 for example, and may include one or more components of a poll that allow a poll to be linked to, or otherwise inserted into, another document, application, presentation, etc. In some instances, the poll wrapper 808 may include information, or data, that allows an application, document, presentation etc. to access data about a poll, to cause updated information to be received, or otherwise received updated information concerning the poll, such as the poll results. In some examples, information necessary to create or otherwise insert a poll into an application, document, or presentation, may be included in an initial object wrapper, such as the poll wrapper 808. In some examples, subsequent poll wrappers may include only information that has changed since the poll was inserted; for example, if poll results have changed, only the new poll results may be sent. Accordingly, the poll wrapper 808 may provide the necessary information for the document, application, or presentation to display the poll and then receive or make a request for subsequent updates. Since only updates may be sent at a later time, an amount information transferred from one device to another device may be reduced.

The poll wrapper 808 may include poll related information, for example, a poll type (multiple choice, open forum, suggestive etc.) and poll customization or skins. In some instances, the poll wrapper 808 may include poll information, such as the question, the results, etc. that allow an object, such as a document, application, or presentation, to recreate and update the poll. In some examples, the poll object 808, or poll wrapper object, may simply be a graphic depicting the poll 804. For example, application unable to dynamically request and/or receive information related to a poll and then update the display of the poll may receive an updated graphic displaying the updated information. While this approach may increase an amount of data needed to be transferred from one device to another device, applications that may not be directly compatible with displaying a poll 804 may still display updated poll information based on receiving an updated graphic.

In accordance with examples of the present disclosure, a device, such as the device 116 previously discussed, may receive a poll wrapper 808; upon installing, inserting, or otherwise including the poll wrapper 808 in a document, application, or presentation, the poll can cause the device 116 to make requests and/or receive updated poll information 816 from the messaging, conferencing, & collaboration system 104. The updated information may then be incorporated into a poll for display. In some instance, the poll, when displayed, such as poll 804, may allow a user to change a previous response and/or even provide a response to an outstanding poll. Accordingly, a user may click on the poll, for example by clicking at 820, which may respond with a graphical element that allows a user to submit a response. Similar to the previously described polls and information included in the polls, the poll 804 may include additional information such who created and a status of the poll (e.g., is the poll open or closed to responses).

FIG. 9 is a block diagram illustrating physical components (e.g., hardware) of a computing device 900 with which aspects of the disclosure may be practiced. The computing device components described below may be suitable for the computing devices, such as the client device 116, and/or the messaging, conferencing, and collaboration system 108, as described above. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for performing the various aspects disclosed herein such as the polling system 922, interface components 924, calendar 923, and/or the grouping organizational system 921. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the at least one processing unit 902, the program modules 906 (e.g., one or more applications 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916A allowing communications with other computing devices 950. Examples of suitable communication connections 916A include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

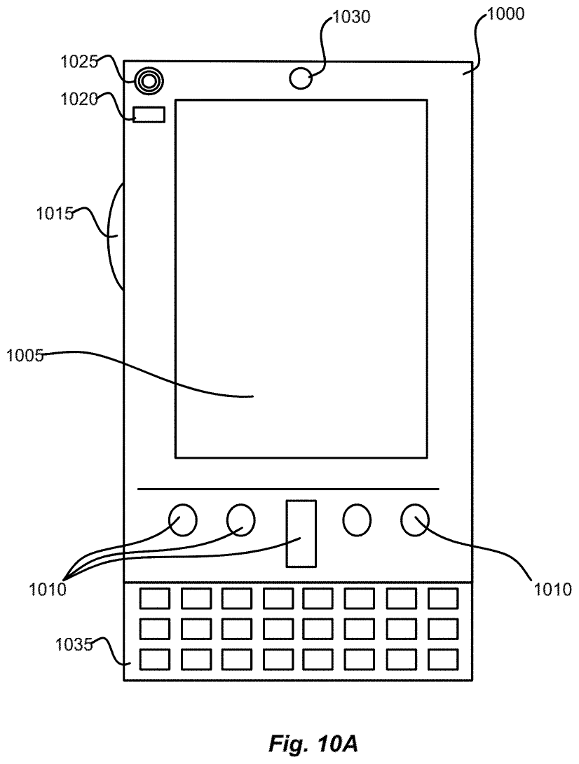

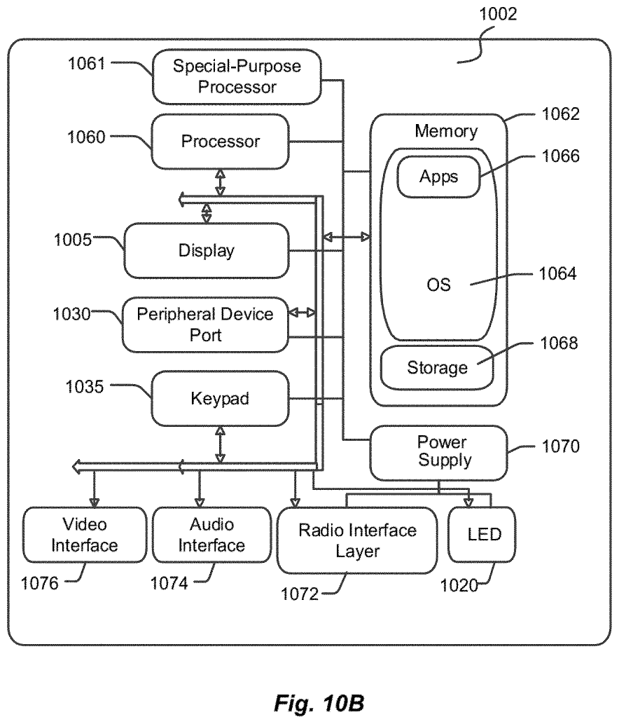

FIGS. 10A and 10B illustrate a computing device, client device, or mobile computing device 1000, for example, a mobile telephone, a smart phone, wearable computer (such as a smart watch), a tablet computer, a laptop computer, and the like, with which aspects of the disclosure may be practiced. In some aspects, the client device (e.g., 116A-116C) may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some aspects. In yet another alternative aspect, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various aspects, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external source.

FIG. 10B is a block diagram illustrating the architecture of one aspect of computing device, a server, or a mobile computing device. That is, the computing device 1000 can incorporate a system (e.g., an architecture) 1002 to implement some aspects. The system 1002 can implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, title content, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated configuration, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

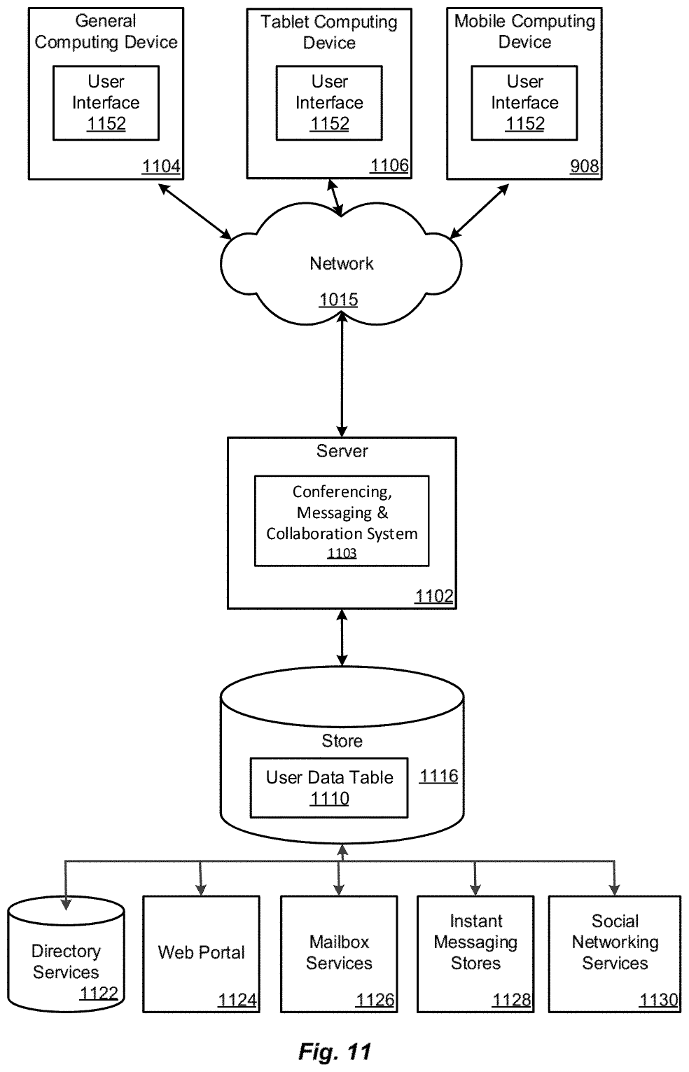

FIG. 11 illustrates one aspect of the architecture of a system for processing data received at a communication, messaging, conferencing, and collaboration system 1103 from a remote source, as described above. Content at a server device 1102 may be stored in different communication channels or other storage types. For example, various images, or files may be stored using a directory service 1122, a web portal 1124, a mailbox service 1126, an instant messaging store 1128, or a social networking site 1130. A unified profile API based on the user data table 1110 may be employed by a client that communicates with server device 1102. The server device 1102 may provide data to and from a client computing device such as the client devices 1104-1108 through a network 1115. By way of example, the client device 1106 described above may be embodied in a personal computer 1104, a tablet computing device 1106, and/or a mobile computing device 1108 (e.g., a smart phone).

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In accordance with at least on example of the present disclosure, a system for displaying a dashboard interface associated with a plurality of polls is provided. The system may include a processor, and memory including instructions which when executed by the processor, causes the processor to: receive a user identifier uniquely identifying a user of a system, determine one or more organizational units associated with the user identifier, and cause a dashboard interface associated with a plurality of polls to be rendered at a display, wherein information of a first poll associated with a first organizational unit of the one or more organizational units is provided in a first portion of the dashboard interface and information of a second poll associated with a second organizational unit of the one or more organizational units is provided in a second portion of the dashboard interface.

At least one aspect of the above example includes instructions, which when executed by the processor, causes the processor to receive an organizational unit associated with the first poll, determine that the user identifier is assigned to a role of owner for the first poll, and cause a visual indication associated with the role of owner to be provided with the information of the first poll at the dashboard interface. At least one aspect of the above example includes instructions, which when executed by the processor, causes the processor to receive a request to modify the first poll, the request including the user identifier, receive a plurality of roles associated with the first poll, determine that the user identifier is associated with at least one roll of the plurality of rolls associated with the first poll, and apply the modification in accordance with at least one roll of the plurality of rolls associated with the first poll. At least one aspect of the above example includes instructions, which when executed by the processor, causes the processor to receive a request to modify the second poll, the request including the user identifier, receive a plurality of roles associated with the second poll, determine that the user identifier is not associated with the plurality of rolls associated with the second poll, and deny the received request to modify the second poll. At least one aspect of the above example includes where information of the first poll provided in the first portion of the dashboard interface includes at least one of a first poll topic, a first poll opening time, a first poll closing time, updated results of the first poll, a number of responses to the first poll, and a number of outstanding responses to the first poll. At least one aspect of the above example includes instructions, which when executed by the processor, causes the processor to receive an indication of a hover event associated with the first poll, and cause a window providing additional information of the first poll to be displayed at the dashboard interface, wherein the additional information of the first poll includes poll information different from the information of the first poll provided in the first portion of the dashboard interface. At least one aspect of the above example includes instructions, which when executed by the processor, causes the processor to generate a poll object including a link to poll results of the first poll, and provide updated poll results to an application associated with the poll object.

In accordance with at least on example of the present disclosure, a method for displaying a dashboard interface associated with a plurality of polls is provided. The method may include receiving a user identifier uniquely identifying a user of a system, determining one or more organizational units associated with the user identifier, and causing a dashboard interface associated with a plurality of polls to be rendered, wherein information of a first poll associated with a first organizational unit of the one or more organizational units and based on a first role associated with the user identifier is provided in a first portion of the dashboard interface and information of a second poll associated with a second organizational unit of the one or more organizational units and based on a second role associated with the user identifier is provided in a second portion of the dashboard interface.

At least one aspect of the above example includes receiving an organizational unit associated with the first poll, determining that the second role is that of an owner for the first poll, and causing a visual indication associated with the role of owner to be provided with the information of the first poll at the dashboard interface. At least one aspect of the above example includes receiving a request to modify the first poll, the request including the user identifier, receiving a plurality of roles associated with the first poll, determining that the first role associated with the user identifier is associated with at least one roll of the plurality of rolls associated with the first poll, and applying the modification in accordance with at least one roll of the plurality of rolls associated with the first poll. At least one aspect of the above example includes receiving a request to modify the second poll, the request including the user identifier, receiving a plurality of roles associated with the second poll, determining that the user identifier is not associated with the plurality of rolls associated with the second poll, and denying the received request to modify the second poll. At least one aspect of the above example includes where information of the first poll provided in the first portion of the dashboard interface includes at least one of a first poll topic, a first poll opening time, a first poll closing time, updated results of the first poll, a number of responses to the first poll, and a number of outstanding responses to the first poll. At least one aspect of the above example includes receiving an indication of a hover event associated with the first poll, and causing a window providing additional information of the first poll to be displayed at the dashboard interface, wherein the additional information of the first poll includes poll information different from the information of the first poll provided in the first portion of the dashboard interface. At least one aspect of the above example includes generating a poll object including a link to poll results of the first poll, and providing updated poll results to an application associated with the poll object. At least one aspect of the above example includes providing an image including the updated poll results to the application associated with the poll object.

In accordance with at least one example of the present disclosure, a computer-readable storage medium is provided. The computer-readable storage medium includes instructions, which when executed by a processor, cause the processor to receive a user identifier uniquely identifying a user of a system, determine one or more roles associated with the user identifier, and cause a dashboard interface associated with a plurality of polls to be rendered at a display, wherein information of a first poll associated with a first role is provided in a first portion of the dashboard interface and information of a second poll associated with a second role is provided in a second portion of the dashboard interface.

At least one aspect of the above example includes where information of the first poll provided in the first portion of the dashboard interface includes at least one of a first poll topic, a first poll opening time, a first poll closing time, updated results of the first poll, a number of responses to the first poll, and a number of outstanding responses to the first poll. At least one aspect of the above example includes instructions that cause the processor to generate a poll object including a link to poll results of the first poll, and provide updated poll results to an application associated with the poll object. At least one aspect of the above example includes instructions that cause the processor to provide an image including the updated poll results to the application associated with the poll object. At least one aspect of the above example includes where one or more roles associated with the user identifier restricts the poll results from being displayed.

1. A system for rendering a dashboard interface for providing information related to a plurality of polls associated with a user, the system comprising:
a processor; and
memory including instructions which when executed by the processor, causes the system to:
receive a user identifier uniquely identifying a user of a system;
determine a plurality of organizational units associated with the user identifier, the plurality of organizational units including first and second organizational units;
identify, based on the user identifier, a plurality of polls associated with the user;
identify, from the plurality of polls associated with the user, a first poll group comprising one or more polls associated with the first organizational unit and a second poll group comprising one or more polls associated with the second organizational unit and
render a dashboard interface associated with the plurality of polls for displaying via a display, wherein the dashboard interface comprises:
a first portion displaying first poll group information identifying the one or more polls of the first poll group associated with the first organizational unit; and
a second portion displaying second poll group information identifying the one or more polls of the second poll group associated with the second organizational unit.

2. The system of claim 1, wherein:
the plurality of polls comprises a first poll, and
the instructions, which when executed by the processor, further causes the system to:
determine that the user identifier is associated with a poll owner role for the first poll; and
render the dashboard interface to display a visual indication that the user is associated with the poll owner role of the first poll.

3. The system of claim 1, wherein:
the plurality of polls comprises a first poll, and
the instructions, which when executed by the processor, further causes the system to:
receive, from the user, a user request to modify the first poll;
determine that the user identifier is associated with a permission to modify the first poll; and
in response to determining that the user identifier is associated with the permission to modify the first poll, modify the first poll based on the received user request.

4. The system of claim 1, wherein:
the plurality of polls comprises a first poll; and
the instructions, which when executed by the processor, further causes the system to:
receive, from the user, a user request to modify the first poll;
determine that the user identifier is not associated with a permission to modify the first poll; and
deny the received user request.

5. The system of claim 1, wherein the first and second poll group information includes at least one of a poll topic, a poll opening time, a poll closing time, poll updated results, a number of poll responses, and a number of outstanding poll responses.

6. The system of claim 1, wherein:
the one or more polls of the first poll group comprise a first poll; and
the instructions, which when executed by the processor, further causes the system to:
receive an indication of a hover event associated with the first poll displayed at the first portion of the dashboard interface; and
in response to receiving the indication, render the dashboard interface to display a window providing additional information of the first poll including poll information that is different from information of the first poll provided in the first portion of the dashboard interface.

7. The system of claim 1, wherein:
the plurality of polls comprises a first poll, and
the instructions, which when executed by the processor, further causes the system to:
generate a poll object including a link to poll results of the first poll; and
provide updated poll results to an application associated with the poll object.

8-20. (canceled)

21. A method of operating a system for rendering a dashboard interface for providing information related to a plurality of polls associated with a user, the method comprising:
receiving a user identifier uniquely identifying a user of a system;
determining a plurality of organizational units associated with the user identifier, the plurality of organizational units including first and second organizational units;
identifying, based on the user identifier, a plurality of polls associated with the user;
identifying, from the plurality of polls associated with the user, a first poll group comprising one or more polls associated with the first organizational unit and a second poll group comprising one or more polls associated with the second organizational unit; and
rendering a dashboard interface associated with the plurality of polls for displaying via a display, wherein the dashboard interface comprises:
a first portion displaying first poll group information identifying the one or more polls of the first poll group associated with the first organizational unit; and
a second portion displaying second poll group information identifying the one or more polls of the second poll group associated with the second organizational unit.

22. The method of claim 21, wherein:
the plurality of polls comprises a first poll, and
the method further comprises:
determining that the user identifier is associated with a poll owner role for the first poll; and
rendering the dashboard interface to display a visual indication that the user is associated with the poll owner role of the first poll.

23. The method of claim 21, wherein:
the plurality of polls comprises a first poll, and
the method further comprises:
receiving, from the user, a user request to modify the first poll;
determining that the user identifier is associated with a permission to modify the first poll; and
in response to determining that the user identifier is associated with the permission to modify the first poll, modifying the first poll based on the received user request.

24. The method of claim 21, wherein:
the plurality of polls comprises a first poll, and
the method further comprises:
receiving, from the user, a user request to modify the first poll;
determining that the user identifier is not associated with a permission to modify the first poll; and
denying the received user request.

25. The method of claim 21, wherein the first and second poll group information includes at least one of a poll topic, a poll opening time, a poll closing time, poll updated results, a number of poll responses, and a number of outstanding poll responses.

26. The method of claim 21, wherein:
the one or more polls of the first poll group comprise a first poll, and
the method further comprises:
receiving an indication of a hover event associated with the first poll displayed at the first portion of the dashboard interface; and
in response to receiving the indication, rendering the dashboard interface to display a window providing additional information including poll information that is different from information of the first poll provided in the first portion of the dashboard interface.

27. The method of claim 21, wherein:
the plurality of polls comprises a first poll, and
the method further comprises:
generating a poll object including a link to poll results of the first poll; and
providing updated poll results to an application associated with the poll object.

28. A non-transitory computer readable medium containing instructions which, when executed by a processor, cause a data processing system to perform functions of:
receiving a user identifier uniquely identifying a user of a system;
determining a plurality of organizational units associated with the user identifier, the plurality of organizational units including first and second organizational units;
identifying, based on the user identifier, a plurality of polls associated with the user;
identifying, from the plurality of polls associated with the user, a first poll group comprising one or more polls associated with the first organizational unit and a second poll group comprising one or more polls associated with the second organizational unit; and
rendering a dashboard interface associated with the plurality of polls for displaying via a display, wherein the dashboard interface comprises:
a first portion displaying first poll group information identifying the one or more polls of the first poll group associated with the first organizational unit; and
a second portion displaying second poll group information identifying the one or more polls of the second poll group associated with the second organizational unit.

29. The non-transitory computer readable medium of claim 28, wherein:
the plurality of polls comprises a first poll, and
the instructions, when executed by the processor, further cause the data processing system to perform functions of:
determining that the user identifier is associated with a poll owner role for the first poll; and
rendering the dashboard interface to display a visual indication that the user is associated with the poll owner role of the first poll.

30. The non-transitory computer readable medium of claim 28, wherein:
the plurality of polls comprises a first poll, and
the instructions, when executed by the processor, further cause the data processing system to perform functions of:
receiving, from the user, a user request to modify the first poll;
determining that the user identifier is associated with a permission to modify the first poll; and
in response to determining that the user identifier is associated with the permission to modify the first poll, modifying the first poll based on the received user request.

31. The non-transitory computer readable medium of claim 28, wherein the first and second poll group information includes at least one of a poll topic, a poll opening time, a poll closing time, poll updated results, a number of poll responses, and a number of outstanding poll responses.

32. The non-transitory computer readable medium of claim 28, wherein:
the one or more polls of the first poll group comprise a first poll, and
the instructions, when executed by the processor, further cause the data processing system to perform functions of:
receiving an indication of a hover event associated with the first poll displayed at the first portion of the dashboard interface; and
in response to receiving the indication, rendering the dashboard interface to display a window providing additional information including poll information that is different from information of the first poll provided in the first portion of the dashboard interface.

33. The non-transitory computer readable medium of claim 28, wherein:
the plurality of polls comprises a first poll, and
the instructions, when executed by the processor, further cause the data processing system to perform functions of:
generating a poll object including a link to poll results of the first poll; and
providing updated poll results to an application associated with the poll object.
